(19) United States
(12) Patent Application Publication
(10) Pub. No.: US 2020/0184909 A1
(43) Pub. Date: Jun. 11, 2020

(54) LIQUID CRYSTAL DISPLAY DEVICE

(71) Applicant: SHARP KABUSHIKI KAISHA, Sakai City, Osaka (JP)

(72) Inventors: Mitsuhiro MURATA, Sakai City (JP); Takuma TOMOTOSHI, Sakai City (JP); Yosuke IWATA, Sakai City (JP)

(73) Assignee: Sharp Kabushiki Kaisha, Sakai City, Osaka (JP)

(21) Appl. No.: 16/336,036

(22) PCT Filed: Sep. 22, 2017
(86) PCT No.: PCT/JP2017/034186

§ 371 Date: Mar. 22, 2019

(30) Foreign Application Priority Data
Sep. 29, 2016 (JP) 2016-191701

(51) Int. Cl. G09G 3/34; G02F 1/1337; G02F 1/137; G09G 3/36

(52) U.S. Cl. CPC G09G 3/3406; G02F 1/1337; G02F 1/137; G09G 3/3677; G09G 2320/0626; G02F 2001/13706; G09G 2320/0252; G09G 2320/0233; G09G 2320/0686; G02F 2001/133738

(57) ABSTRACT

The liquid crystal display device according to the present invention includes a first substrate, a second substrate, a liquid crystal layer, and a display region including multiple display units arranged in a matrix. The first substrate includes a first electrode, and a second electrode. Liquid crystal molecules are aligned parallel to the first substrate in a no-voltage-applied state. The second electrode in each of the display units is provided with an opening having a certain shape. The display units include at least one high-speed display unit in which four liquid crystal domains are generated in the light-transmitting region in a voltage-applied state and at least one high-luminance display unit in which two liquid crystal domains are generated in the light-transmitting region in the voltage-applied state. A data signal is written in the at least one high-speed display unit later than in the high-luminance display unit within one frame period.

### TECHNICAL FIELD

The present invention relates to a liquid crystal display device. In particular, the present invention relates to a liquid crystal display device suitable as a horizontal alignment mode liquid crystal display device provided with high-definition pixels.

### BACKGROUND ART

Liquid crystal display devices are display devices that utilize a liquid crystal composition for display. The typical display mode thereof is applying voltage to a liquid crystal composition sealed between paired substrates to change the alignment state of liquid crystal molecules in the liquid crystal composition according to the applied voltage, thereby controlling the amount of light transmitted. These liquid crystal display devices, having characteristics such as thin profile, light weight, and low power consumption, have been used in a broad range of fields.

The display modes of liquid crystal display devices include horizontal alignment modes, in which the alignment of liquid crystal molecules is controlled by rotation of the liquid crystal molecules mainly in a plane parallel to the substrate surfaces. The horizontal alignment modes have received attention because these modes make it easy to achieve wide viewing angle characteristics. For example, in recent years, liquid crystal display devices for smartphones and tablet terminals have widely used an in-plane switching (IPS) mode and a fringe field switching (FFS) mode, each of which is one type of horizontal alignment mode.

There is continuing research and development of the horizontal alignment modes to achieve higher definition pixels and an improved response speed to improve display quality. As a technique for improving the response speed, for example, Patent Literature 1 discloses a technique related to a liquid crystal display device using a fringe electric field, in which technique a first electrode is provided with a comb tooth portion of a specific shape. In addition, Patent Literature 2 discloses an electrode structure related to an FFS mode liquid crystal display, which is provided with a slit including two linear portions and a V-shaped portion formed by connecting the two linear portions in a V shape.

### CITATION LIST

### Patent Literature

Patent Literature 1: JP 2015-114493 A
Patent Literature 2: WO 2013/021929 A1

### SUMMARY OF INVENTION

### Technical Problem

“Image blurring” which occurs when an image is displayed using a liquid crystal display device is a phenomenon in which the contour of an image is recognized in a blurred state by an observer. A delay in response of liquid crystal molecules is regarded as one cause of this phenomenon. Horizontal alignment mode liquid crystal display devices offer the advantage of wide viewing angles, but have the problem that they are slow in response as compared with vertical alignment modes such as a multi-domain vertical alignment (MVA) mode, and hence image blurring tends to occur.

FIG. 23 is a view relating to the FFS mode liquid crystal display device according to Comparative Embodiment 1 studied by the present inventors, in which (a) is a plan view showing the opening shape of an electrode, and (b) is a plan view showing the simulation result of the alignment distribution of liquid crystal molecules in the voltage-applied state. FIG. 24 is a view relating to the FFS mode liquid crystal display device according to Comparative Embodiment 1 studied by the present inventors and a graph showing a luminance curve in a display unit in which a data signal is written in the first half of one frame and a display unit in which a data signal is written in the second half of the frame.

In the FFS mode liquid crystal display device of Comparative Embodiment 1 provided with a pixel electrode 112, for example, an opening 115 having the shape shown in FIG. 23(a) is formed in the counter electrode, and in the voltage-applied state, one liquid crystal domain is generated in a light-transmitting region 170. That is, in the FFS mode liquid crystal display device according to Comparative Embodiment 1, there is no boundary (dark lines) of the liquid crystal domain through which light is not transmitted in the light-transmitting region 170 in one display unit 150.

In the FFS mode liquid crystal display device according to Comparative Embodiment 1, in particular, when raising the number of display frames per second from 60 frames to 120 frames (60 Hz to 120 Hz), the following problems sometimes occur.

In the FFS mode liquid crystal display device according to Comparative Embodiment 1 having multiple gate signal lines sequentially scanned in the scan direction indicated by the arrow in FIG. 24, in the display unit 150 in which a data signal is written in the first half of one frame, as indicated by a luminance curve 161 in FIG. 24, liquid crystal molecules respond sufficiently near the end of one frame, and high luminance is obtained in a period 163 during which the backlight lights up. However, in the display unit 150 in which a data signal is written in the second half of one frame, as indicated by a luminance curve 162 in FIG. 24, in the period 163 during which the liquid crystal molecules cannot respond within one frame and the backlight lights up, sufficient luminance cannot be obtained. As a result, in a region corresponding to the display unit 150 in which a data signal is written in the second half of one frame, for example, in a lower portion of the display region, a phenomenon of image blurring is sometimes recognized. Referring to FIG. 24, a data signal is written at the time of “gate ON”.

Although the response speed can be improved in the horizontal mode by using the technique disclosed in Patent Literature 1, the shape of the electrode is largely restricted by an ultrahigh-definition pixels of not less than 800 ppi, for example. This makes it difficult to adopt a complicated electrode shape like that disclosed in Patent Literature 1.

According to Patent Literature 2, due to the influence of the V-shaped portion provided in the opening of the electrode, it is possible to improve the display performance such as transmittance by dividing the alignment of the liquid crystal molecules into two regions at the time of voltage application. However, the effect of speeding up is not great.

As a result of various studies, the present inventors have found that the response speed of liquid crystal molecules decreases in the FFS mode liquid crystal display device according to Comparative Embodiment 1 described above because only one liquid crystal domain exists in a light-transmitting region 170 in the voltage-applied state and there is no wall that generates a force in a direction opposite to the rotating direction of liquid crystal molecules, and have also found that high speed can be achieved in an FFS mode liquid crystal display device even in the horizontal alignment mode by using the strain force generated by the bend and splay liquid crystal alignments formed in a narrow region by rotating liquid crystal molecules within a range smaller than a certain pitch in the voltage-applied state to form four liquid crystal domains and rotating the liquid crystal molecules in the adjacent liquid crystal domains in opposite directions.

FIG. 25 is a schematic plan view of a counter electrode in a FFS mode liquid crystal display device of Comparative Embodiment 2 studied by the present inventors. FIG. 26 is a plan view showing the simulation results of alignment distribution of liquid crystal molecules in the voltage-applied state in the FFS mode liquid crystal display device of Comparative Embodiment 2 studied by the present inventors.

As shown in FIG. 25, in the FFS mode liquid crystal display device according to Comparative Embodiment 2, a counter electrode 114 having an opening 115 is disposed on the upper layer, and a pixel electrode (not shown) is disposed on the lower layer. The opening 115 is constituted by a longitudinal-shaped portion 116 and a pair of protrusions 117 protruding to opposite sides from the longitudinal-shaped portion 116, and has a shape symmetrical with respect to an alignment azimuth 122 of liquid crystal molecules 121 in the no-voltage-applied state.

As shown in FIG. 26, in the FFS mode liquid crystal display device according to Comparative Embodiment 2, the liquid crystal molecules 121 rotate upon voltage application, and four liquid crystal domains in which the alignments of the liquid crystal molecules 121 are symmetrical to each other are formed. Furthermore, the electric field in the oblique direction at the pair of protrusions 117 allows the four liquid crystal domains to stably exist, thereby improving the response characteristics.

However, in the liquid crystal display device according to Comparative Embodiment 2, because the four liquid crystal domains are formed in one display unit 150 for one opening 115, cross-shaped dark lines as indicated by the portion surrounded by the dotted line in FIG. 26 are generated in the central portion of the display unit 150, resulting in a decrease in luminance. In this way, specializing in the high-speed performance of the liquid crystal display device causes a decrease in the luminance of the entire surface of the liquid crystal panel. For applications observed from close range such as a head mount display (HMD) mounted on the user's head, a reduction in luminance at an end portion of the display region is lower in influence on display quality than a reduction in luminance at a central portion of the display region, and hence is acceptable. However, in such applications as well, it is necessary to avoid a reduction in luminance over the entire surface of the display region.

The present invention has been made in view of such a current state of the art and aims to provide a high definition liquid crystal display device in which image blurring is suppressed while reduction in luminance is suppressed at least at part of a display region.

### Solution to Problem

As a result of extensive studies on a high definition liquid crystal display device in which image blurring is suppressed while reduction in luminance is suppressed at least at part of the display region, the inventors of the present invention have paid attention to four liquid crystal domains in Comparative Embodiment 2 described above. In each display unit, an opening including a longitudinal-shaped portion and a pair of protrusions protruding to opposite sides from the longitudinal-shaped portion is formed in the electrode of the upper layer, and the pair of protrusions are provided on the longitudinal-shaped portion except for its both end portions in the longitudinal direction so as to be disposed in places corresponding to each other. This makes it unnecessary to form an opening having a complicated shape in the second electrode and makes it possible to achieve high definition. It has also been found that the response speed can be increased in each display unit by the four liquid crystal domains as in Comparative Embodiment 2 described above.

It has been found that providing a high-speed display unit in which four liquid crystal domains are generated in a light-transmitting region and a high-luminance display unit in which two liquid crystal domains are generated in a light-transmitting region, as display units, reduces the distortion (twisting force) of the liquid crystal alignment occurring in the voltage-applied state in the high-luminance display unit as compared with the high-luminance display unit, and hence the response speed is relatively slow, whereas in the light-transmitting region, because the region occupied by dark lines between the adjacent liquid crystal domains in the light-transmitting region can be reduced as compared with the high-speed display unit, the transmittance can be relatively increased. On the other hand, it has been found that in the high-speed display unit, because the region occupied by the dark lines between the adjacent liquid crystal domains in the light-transmitting region is larger than that in the high-luminance display unit, the transmittance becomes relatively small, whereas the response speed can be relatively increased because the distortion (twisting power) of liquid crystal alignment occurring in the voltage-applied state can be made larger than that in the high-luminance display unit.

It has been found that by writing a data signal in the high-speed display unit later than in the high-luminance display unit within one frame period, the time for liquid crystal response for the high-luminance display unit having a relatively low response speed can be ensured, and hence the occurrence of image blurring can be reduced in the region provided with the high-luminance display unit, whereas although the time for liquid crystal response with respect to the high-speed display unit is shortened, because the response speed is relatively high, the occurrence of image blurring can be reduced even in a region provided with the high-speed display unit.

As described above, it has been found that the occurrence of image blurring can be reduced in the region provided with the high-luminance display unit and the region provided with the high-speed display unit while a reduction in luminance in the region provided with the high-luminance display unit is reduced. It has also been found that it is possible to achieve high definition of each display unit. As a result, it has been conceived that the above problems can be solved satisfactorily to achieve the present invention.

That is, one aspect of the present invention may be a liquid crystal display device including a first substrate, a second substrate facing the first substrate, a liquid crystal layer provided between the first substrate and the second substrate and containing liquid crystal molecules, and a display region including multiple display units arranged in a matrix, wherein the first substrate includes a first electrode, a second electrode provided closer to the liquid crystal layer than the first electrode, and an insulating film provided between the first electrode and the second electrode, the liquid crystal molecules are aligned parallel to the first substrate in a no-voltage-applied state in which no voltage is applied between the first electrode and the second electrode, the second electrode in each of the display units is provided with an opening including a longitudinal-shaped portion and a pair of protrusions protruding to opposite sides from the longitudinal-shaped portion, the pair of protrusions are provided on portions excluding both the end portions of the longitudinal-shaped portion in a longitudinal direction and located in places corresponding to each other, each of the display units includes a light-transmitting region which can transmit light and a light-blocking region which blocks light in a plan view, the light-transmitting region is formed so as to overlap the longitudinal-shaped portion in each of the display units, the display units including at least one high-speed display unit in which four liquid crystal domains are generated in the light-transmitting region in a voltage-applied state in which a voltage is applied between the first electrode and the second electrode and at least one high-luminance display unit in which two liquid crystal domains are generated in the light-transmitting region in the voltage-applied state, and a data signal is written in the at least one high-speed display unit later than in the at least one high-luminance display unit within one frame period.

The pair of protrusions of the at least one high-speed display unit may be located in a region combining the light-transmitting region and a region obtained by virtually expanding the light-transmitting region in the transverse direction of the longitudinal-shaped portion in a plan view.

The pair of protrusions of the at least one high-speed display unit may protrude from an intermediate portion of the longitudinal-shaped portion.

The pair of protrusions of the at least one high-luminance display unit may be located outside a region combining the light-transmitting region and a region obtained by virtually expanding the light-transmitting region in a transverse direction of the longitudinal-shaped portion in a plan view.

The pair of protrusions of the at least one high-luminance display unit may be adjacent to one of the end portions of the longitudinal-shaped portion.

The at least one high-speed display unit may be located at an end of the display region.

The liquid crystal molecules may have positive anisotropy of dielectric constant.

The longitudinal direction of the longitudinal-shaped portion may be parallel to the alignment azimuth of the liquid crystal molecules in a plan view in the no-voltage-applied state.

The liquid crystal display device may further include a backlight provided on an opposite side of the first substrate or the second substrate to the liquid crystal layer. A luminance of the backlight in a region corresponding to the at least one high-speed display unit may be higher than a luminance of the backlight in a region corresponding to the at least one high-luminance display unit.

The backlight may include a light source that lights up for a predetermined time in one frame period. The light source may start lighting at a later time than when the at least one high-speed display unit is driven.

The backlight may include a light guide plate facing the first substrate or the second substrate and a light source configured to irradiate a light incident surface of the light guide plate with light, and the at least one high-speed display unit may be located closer to the light incident surface of the light guide plate than the at least one high-luminance display unit.

The first substrate may further include multiple gate signal lines which are provided for each row or column of the display units and which are scanned line-sequentially in a predetermined direction, and the at least one high-speed display unit may be connected to a gate signal line of a final stage of the gate signal lines.

The display units may include a plurality of the high-speed display units, and each of the high-speed display units may be connected to any of the gate signal lines of consecutive stages including the gate signal line of the final stage among the gate signal lines.

At least one of the end portions of the longitudinal-shaped portion may be rounded.

The at least one high-speed display unit may include cross-shaped dark lines at a center of the four liquid crystal domains.

### Advantageous Effects of Invention

The present invention can provide a high definition liquid crystal display device in which image blurring is suppressed while reduction in luminance is suppressed at least at part of a display region.

### BRIEF DESCRIPTION OF DRAWINGS

FIG. 1 is a schematic cross-sectional view of a liquid crystal display device according to an embodiment of the present invention in a voltage-applied state.

FIG. 2 is a view relating to a high-speed display unit in the liquid crystal display device according to the embodiment of the present invention, in which (a) is a plan view of an opening shape provided in a counter electrode and (b) is a schematic plan view showing a counter electrode.

FIG. 3 is a view relating to a high-speed display unit in the liquid crystal display device according to the embodiment of the present invention, in which (a) is a schematic view for explaining alignment control of liquid crystal molecules in the voltage-applied state, (b) is an enlarged plan view showing a simulation result of the alignment distribution of liquid crystal molecules in the voltage-applied state, and (c) is a plan view showing a simulation result of the alignment distribution of liquid crystal molecules in the voltage-applied state.

FIG. 4 is a schematic plan view illustrating an opening shape of a high-speed display unit in the liquid crystal display device according to the embodiment of the present invention.

FIG. 5 is a view relating to a high-luminance display unit in the liquid crystal display device according to the embodiment of the present invention, in which (a) is a plan view of an opening shape provided in a counter electrode and (b) is a schematic plan view showing a counter electrode.

FIG. 6 is a view relating to a high-luminance display unit in the liquid crystal display device according to the embodiment of the present invention, in which (a) is a schematic view for explaining alignment control of liquid crystal molecules in the voltage-applied state, (b) is an enlarged plan view showing a simulation result of the alignment distribution of liquid crystal molecules in the voltage-applied state, and (c) is a plan view showing a simulation result of the alignment distribution of liquid crystal molecules in the voltage-applied state.

FIG. 7 is a schematic plan view illustrating an opening shape of a high-luminance display unit in the liquid crystal display device according to the embodiment of the present invention.

FIG. 8 is a schematic plan view showing the configuration of the liquid crystal display device according to the embodiment of the present invention.

FIG. 9 is a schematic cross-sectional view showing the configurations of backlights of the liquid crystal display devices according to the embodiment of the present invention, in which (a) is a schematic cross-sectional view of a liquid crystal display device having an edge-light type backlight, and (b) is a schematic cross-sectional view of a liquid crystal display device having a direct type backlight.

FIG. 10 is a view relating to the liquid crystal display device according to the embodiment of the present invention, in which (a) is a schematic plan view showing the arrangement of each display unit, and (b) is a schematic view showing luminance curves in a high-luminance display unit and a high-speed display unit.

FIG. 11 is a view relating to a high-luminance display unit A-1, in which (a) is a plan view showing the opening shape of a counter electrode, and (b) is a plan view showing the simulation result of the alignment distribution of liquid crystal molecules in the voltage-applied state.

FIG. 12 is a view relating to a high-speed display unit B-1, in which (a) is a plan view showing the opening shape of a counter electrode, and (b) is a plan view showing the simulation result of the alignment distribution of liquid crystal molecules in the voltage-applied state.

FIG. 13 is a view relating to a high-speed display unit B-2, in which (a) is a plan view showing the opening shape of a counter electrode, and (b) is a plan view showing the simulation result of the alignment distribution of liquid crystal molecules in the voltage-applied state.

FIG. 14 is a view relating to a high-luminance display unit A-2, in which (a) is a plan view showing the opening shape of a counter electrode, and (b) is a plan view showing the simulation result of the alignment distribution of liquid crystal molecules in the voltage-applied state.

FIG. 15 is a view relating to a high-luminance display unit A-3, in which (a) is a plan view showing the opening shape of a counter electrode, and (b) is a plan view showing the simulation result of the alignment distribution of liquid crystal molecules in the voltage-applied state.

FIG. 16 is a view relating to a high-luminance display unit A-4, in which (a) is a plan view showing the opening shape of a counter electrode, and (b) is a plan view showing the simulation result of the alignment distribution of liquid crystal molecules in the voltage-applied state.

FIG. 17 is a view relating to a high-luminance display unit A-5, in which (a) is a plan view showing the opening shape of a counter electrode, and (b) is a plan view showing the simulation result of the alignment distribution of liquid crystal molecules in the voltage-applied state.

FIG. 18 is a view relating to a high-luminance display unit A-6, in which (a) is a plan view showing the opening shape of a counter electrode, and (b) is a plan view showing the simulation result of the alignment distribution of liquid crystal molecules in the voltage-applied state.

FIG. 19 is a view relating to a high-luminance display unit A-7, in which (a) is a plan view showing the opening shape of a counter electrode, and (b) is a plan view showing the simulation result of the alignment distribution of liquid crystal molecules in the voltage-applied state.

FIG. 20 is a schematic view showing a relationship between the response of liquid crystal molecules and the backlight in the liquid crystal display device according to Embodiment 1.

FIG. 21 is a schematic plan view showing the luminance distribution of the backlight used for each of the liquid crystal display devices according to Embodiments 2-1 to 2-24.

FIG. 22 is a schematic plan view showing the relationship between the arrangement of the display units and the luminance distribution of the backlight in each of the liquid crystal display devices according to Embodiments 2-1 to 2-24.

FIG. 23 is a view relating to an FFS mode liquid crystal display device according to Comparative Embodiment 1, in which (a) is a plan view showing an opening shape of an electrode, and (b) is a plan view showing the simulation result of the alignment distribution of liquid crystal molecules in a voltage-applied state.

FIG. 24 is a view relating to the FFS mode liquid crystal display device according to Comparative Embodiment 1 and a graph showing luminance curves in a display unit in which a data signal is written in a first half of one frame and a display unit in which a data signal is written in a second half of the frame.

FIG. 25 is a schematic plan view of a counter electrode in an FFS mode liquid crystal display device of Comparative Embodiment 2.

FIG. 26 is a plan view showing the simulation result of the alignment distribution of liquid crystal molecules in the voltage-applied state in the FFS mode liquid crystal display device according to Comparative Embodiment 2.

FIG. 27 is a view relating to a display unit R-1 in an FFS mode liquid crystal display device according to Comparative Embodiment 1-1, in which (a) is a plan view showing an opening shape of a counter electrode, and (b) is a plan view showing the simulation result of the alignment distribution of liquid crystal molecules in a voltage-applied state.

FIG. 28 is a schematic view showing luminance curves in a display unit of the liquid crystal display device according to Comparative Embodiment 1-2.

### DESCRIPTION OF EMBODIMENTS

Hereinafter, embodiments of the present invention will be described. The following embodiments, however, are not intended to limit the scope of the present invention. The present invention may appropriately be modified within the scope of the configuration of the present invention. In the following description, the same reference numerals denote the same parts or parts having similar functions in different drawings, and a repetitive description thereof is omitted. The configurations described in the embodiments may appropriately be combined or modified within the spirit of the present invention.

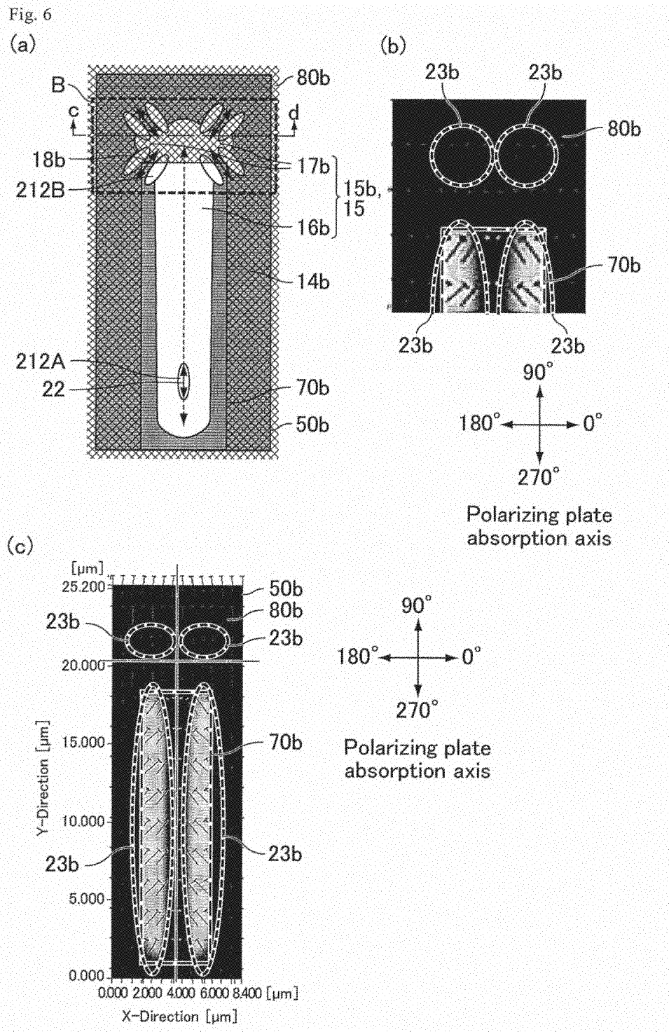

FIG. 1 is a schematic cross-sectional view of a liquid crystal display device according to an embodiment of the present invention in a voltage-applied state. FIG. 1 shows a cross section taken along line c-d in FIGS. 3 and 6 described later.

As shown in FIG. 1, a liquid crystal display device 1 according to an embodiment of the present invention includes, in the given order, a first substrate 10, a liquid crystal layer 20 containing liquid crystal molecules 21, and a second substrate 30. The first substrate 10 is an array substrate and has a stacked structure including, in order toward the liquid crystal layer 20, a first polarizer (not shown), an insulating substrate (for example, glass substrate) 11, a pixel electrode (first electrode) 12, an insulating layer (insulating film) 13, and a counter electrode (second electrode) 14, and the counter electrode 14 is provided with an opening 15. The second substrate 30 is a color filter substrate, and has a stacked structure including a second polarizer (not shown), an insulating substrate (for example, glass substrate) 31, a color filter 32, and an overcoat layer 33 toward the liquid crystal layer 20. A backlight 60 is disposed on the opposite side of the first substrate 10 to the liquid crystal layer 20. The first polarizer and the second polarizer are both absorptive polarizers and disposed in the crossed Nicols with their absorption axes perpendicular to each other. Note that the first substrate 10, the liquid crystal layer 20, the second substrate 30, and the backlight 60 may be arranged in the given order.

Although not shown in FIG. 1, a horizontal alignment film is usually provided on the surface of the first substrate 10 and/or the second substrate 30, the surface being located on the liquid crystal layer 20 side. The horizontal alignment film acts to align the liquid crystal molecules 21 near the film parallel to the film surface. In addition, the horizontal alignment film adjusts the orientations of the major axes (hereinafter also referred to as “alignment azimuths”) of the liquid crystal molecules 21 aligned parallel to the first substrate 10 to a specific in-plane azimuth. The horizontal alignment film preferably has been subjected to alignment treatment such as photo-alignment treatment or rubbing treatment. The horizontal alignment film may be made of an inorganic material or an organic material.

In the no-voltage-applied state, where no voltage is applied between the pixel electrode (first electrode) 12 and the counter electrode (second electrode) 14 (this state is hereinafter also simply referred to as the “no-voltage-applied state”), the alignment of the liquid crystal molecules 21 is controlled parallel to the first substrate 10. The “parallel” herein includes not only being completely parallel, but also a range (substantially parallel) that can be equated with being parallel in the art. The pre-tilt angle (angle of tilt in the no-voltage-applied state) of the liquid crystal molecules 21 is preferably less than 3°, more preferably less than 1° relative to the surface of the first substrate 10, and it is particularly preferable to set the pre-tilt angle to 0° by using a photo-alignment film. When the pre-tilt angle is set to 0°, the influence of the pre-tilt angle on the liquid crystal domain is eliminated, and the balance of the four liquid crystal domains can be easily maintained uniformly. In this specification, the alignment azimuth of the liquid crystal molecules 21 in the no-voltage-applied state is also referred to as an initial alignment azimuth 22 of liquid crystal molecules.

In the voltage-applied state, where a voltage is applied between the pixel electrode (first electrode) 12 and the counter electrode (second electrode) 14 (this state is hereinafter also simply referred to as the “voltage-applied state”), the alignment of the liquid crystal molecules 21 is controlled by the stacked structure of the first substrate 10 including the pixel electrode 12, the insulating layer 13, and the counter electrode 14. In this case, the pixel electrode 12 is an electrode provided for each display unit, and the counter electrode 14 is an electrode shared by multiple display units.

Note that the “display unit” means a region corresponding to one pixel electrode 12. The display unit may be one referred to as a “pixel” in the technical field of liquid crystal display devices, or may be one referred to as a “sub-pixel”, “dot”, or “picture element” in the cases where one pixel is divided for driving. Examples of the alignment of the display units (sub pixels) in the cases where one pixel is divided for driving include a three color stripe arrangement including, for example, red, green and blue, a three color mosaic arrangement or delta arrangement including, for example, red, green and blue, a four color stripe arrangement including, for example, red, green, blue and yellow, and a squared pattern. When the three color stripe arrangement is used, the aspect ratio of the display unit is 3:1; when the four color stripe arrangement is used, the aspect ratio of the display unit is 4:1; and when the three color mosaic arrangement, three color delta arrangement, or four colored squared pattern is used, the aspect ratio of the display unit is 1:1. On the other hand, the aspect ratio of the pixel is usually 1:1 regardless of whether or not the pixel is divided for driving. The shape and number of the openings 15 can be adjusted according to the shape of the display unit. Although the opening 15 includes a longitudinal-shaped portion as will be described later, when the display unit has a longitudinal shape (preferably a rectangular shape) as in the case where the three color stripe arrangement or four color stripe arrangement is employed, it is preferable that the longitudinal direction of the display unit (preferably a direction of a long side of a rectangular shape) is coincident with the longitudinal direction of the longitudinal-shaped portion of the opening 15.

The voltage-applied state means a state where the liquid crystal molecules 21 rotate under the effect of the electric field and a voltage equal to or higher than a minimum voltage (threshold voltage) necessary for changing the alignment azimuth is applied, and may be a state where a voltage at which white display is performed (white voltage) is applied.

Since the counter electrode 14 supplies a potential common to each display unit, the counter electrode 14 may be formed on almost the entire surface of the first substrate 10 (excluding the opening portion for forming a fringe electric field). The counter electrode 14 may be electrically connected to the external connecting terminal at the outer peripheral portion (frame region) of the first substrate 10.

The positions of the counter electrode 14 and the pixel electrode 12 may be switched. Specifically, although in the stacked structure shown in FIG. 1, the counter electrode 14 is adjacent to the liquid crystal layer 20 through a horizontal alignment film (not shown), the pixel electrode 12 may be adjacent to the liquid crystal layer 20 through a horizontal alignment film (not shown). In such a case, an opening 15 including a pair of protrusions in a longitudinal-shaped portion (to be described later) is formed in the pixel electrode 12 instead of the counter electrode 14.

In the stacked structure shown in FIG. 1, the counter electrode 14 is formed with an opening 15 including a longitudinal-shaped portion and a pair of protrusions protruding to opposite sides from the longitudinal-shaped portion to. The liquid crystal display device 1 according to the present embodiment has two types of display units in which the shapes of the openings 15 are different from each other. One display unit is a high-speed display unit specialized for high-speed processing, and the other display unit is a high-luminance display unit with enhanced luminance and response speed. That is, the high-speed display unit is a display unit with a faster response speed and a lower luminance than the high-luminance display unit, and the high-luminance display unit is a display unit with a slower response speed and a higher luminance than the high-speed display unit.

The liquid crystal display device 1 writes a data signal in the high-speed display unit within one frame period later than in the high-luminance display unit. As a result, the time required for liquid crystal to respond in the high-speed display unit is reduced, but because the response speed is fast, image blurring can be suppressed. On the other hand, a data signal is written in the high-luminance display unit at a timing earlier than in the high-speed display unit within one frame period. Accordingly, in the high-luminance display unit having a slow response speed, it is possible to secure time for the liquid crystal to respond, and hence it is possible to suppress image blurring. In addition, in a region provided with at least a high-luminance display unit in the display region, bright display can be obtained. In this case, one frame period is a time for displaying one frame (frame). For example, when the number of display frames per second is 60 (60 frames per second: 50 to 60 Hz), one frame period is 1/60 second. When the number of frames displayed per second is 120 (120 frames per second: 120 Hz) (double speed drive), one frame is 1/120 second. When the number of display frames per second is 240 (240 frames per second: 240 Hz) (quadruple speed drive), one frame is 1/240 second. A typical liquid crystal display device is driven at 50 to 60 frames per second (50 to 60 Hz). In the liquid crystal display device 1 according to the present embodiment, one frame period can be appropriately set, but the liquid crystal display device 1 is suitable for displaying each frame in a frame period shorter than a general frame period. This device is especially suitable for double speed drive or quadruple speed drive, and is more suitable for double speed drive in particular. Each display unit will be described in detail below.

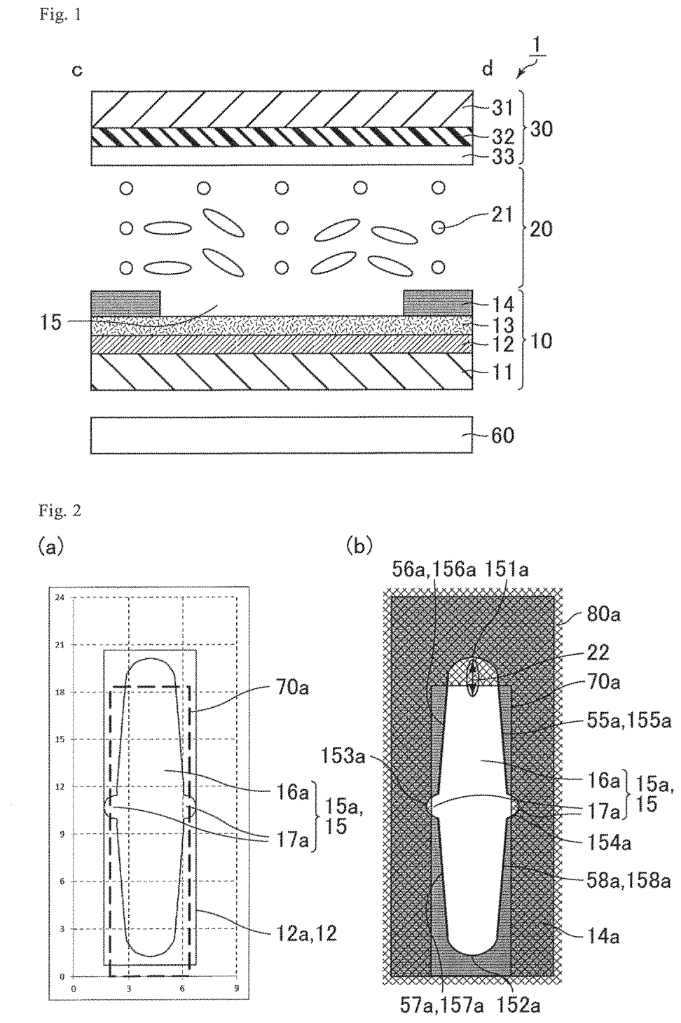

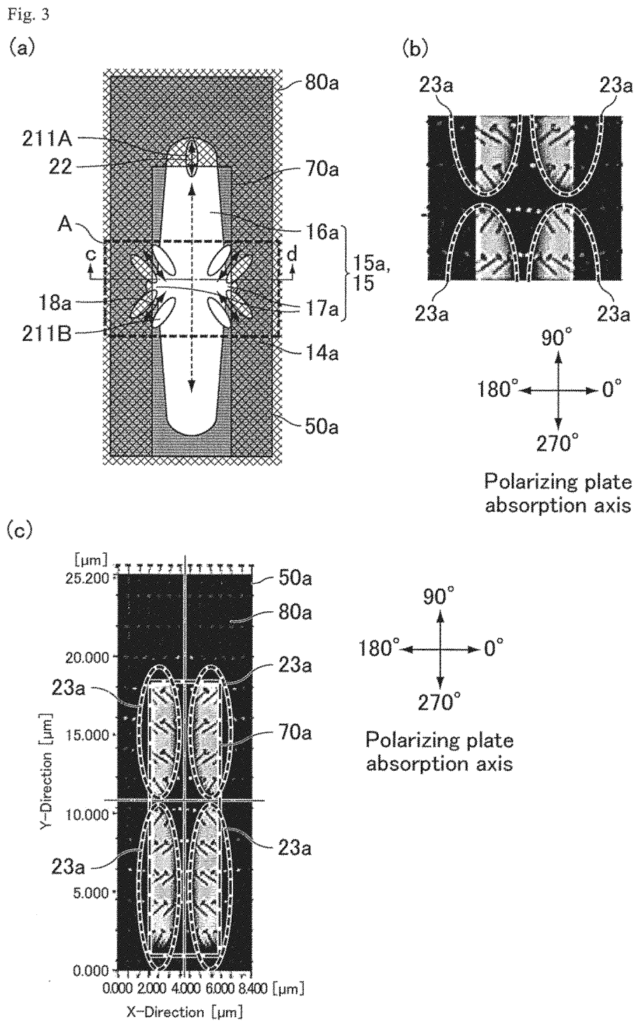

FIG. 2 is a view relating to a high-speed display unit in the liquid crystal display device according to the embodiment of the present invention, in which (a) is a schematic plan view of an opening shape provided in a counter electrode and (b) is a schematic plan view showing a counter electrode. FIG. 3 is a view relating to a high-speed display unit in the liquid crystal display device according to the embodiment of the present invention, in which (a) is a schematic view for explaining alignment control of liquid crystal molecules in the voltage-applied state, (b) is an enlarged plan view showing a simulation result of the alignment distribution of liquid crystal molecules in the voltage-applied state, and (c) is a plan view showing a simulation result of the alignment distribution of liquid crystal molecules in the voltage-applied state. FIG. 3(b) is a simulation result of a region A surrounded by the dotted line in FIG. 3(a). LCD-Master 3D available from Shintech Co., Ltd. was used for simulation in this specification.

As shown in FIGS. 2 and 3, a high-speed display unit 50a has a light-transmitting region 70a and a light-blocking region 80a surrounding the periphery of the light-transmitting region 70a in a plan view. In a voltage-applied state, four liquid crystal domains 23a are generated in the light-transmitting region 70a for one opening 15a. The light-transmitting region 70a is a region that can transmit light. This region transmits and blocks light by changing the voltage applied between a counter electrode 14a and a pixel electrode 12a so as to rotate the liquid crystal molecules 21, thereby adjusting white display, halftone display, and black display. The light-blocking region 80a is a region that blocks light and is a region that always displays black, because a light blocking member such as a black matrix is disposed. Note that in this specification, the liquid crystal domain means a region defined by a boundary where the liquid crystal molecules 21 do not rotate from the initial alignment azimuth 22 of liquid crystal molecules in the voltage-applied state. The boundary between the liquid crystal domains where the liquid crystal molecules 21 do not rotate from the initial alignment azimuth 22 of liquid crystal molecules in the voltage-applied state is also called a disclination. In the liquid crystal display device in a normally black mode, the disclination located in a light-transmitting region is visually recognized as dark lines.

The counter electrode 14a in the high-speed display unit 50a is formed with an opening 15a including a longitudinal-shaped portion 16a and a pair of protrusions 17a protruding to opposite sides from the longitudinal-shaped portion 16a. The light-transmitting region 70a is arranged so as to overlap the longitudinal-shaped portion 16a. The light-transmitting region 70a may overlap at least part of the longitudinal-shaped portion 16a. However, from the viewpoint of further increasing the transmittance, it is preferable that the light-transmitting region 70a overlaps substantially the entire longitudinal-shaped portion 16a and overlaps the region excluding one end portion of the longitudinal-shaped portion 16a.

The longitudinal direction of the longitudinal-shaped portion 16a is parallel to the alignment azimuth of liquid crystal molecules 211A in the no-voltage-applied state (the initial alignment azimuth 22 of liquid crystal molecules). The pair of protrusions 17a are present on the left and right sides of the longitudinal-shaped portion 16a so as to fix cross-shaped dark lines in the central portion of the high-speed display unit 50a and fix the four liquid crystal domains 23a which are vertically and horizontally symmetrical. The pair of protrusions 17a are provided at a portion (hereinafter referred to as an “intermediate portion”) except for both end portions of the longitudinal-shaped portion 16a in the longitudinal direction and located in places corresponding to each other. In addition, the pixel electrode 12a is provided so as to overlap substantially the entire opening 15a. Since the opening 15a is used for forming a fringe electric field (oblique electric field) and does not include a complicated shape, the opening 15a can be applied to ultrahigh-definition pixels of not less than 800 ppi, for example, without any problem. Although the definition of the liquid crystal display device 1 is not particularly limited, it is preferably not less than 400 ppi and not more than 1200 ppi, and more preferably not less than 800 ppi and not more than 1200 ppi. The definition (ppi: pixel per inch) in this specification is represented by the number of pixels arranged per inch (2.54 cm). When one pixel is divided into a plurality of sub-pixels (display units) for driving, the definition may be calculated based on the size of one pixel constituted by a plurality of sub-pixels. When sub-pixels (for example, RGB) of different colors are arranged in a direction parallel to a gate signal line in stripe arrangement, the size in a direction (the longitudinal direction of the sub-pixel) parallel to a source signal line of the sub-pixel corresponds to the size of one pixel in the case of calculating the definition.

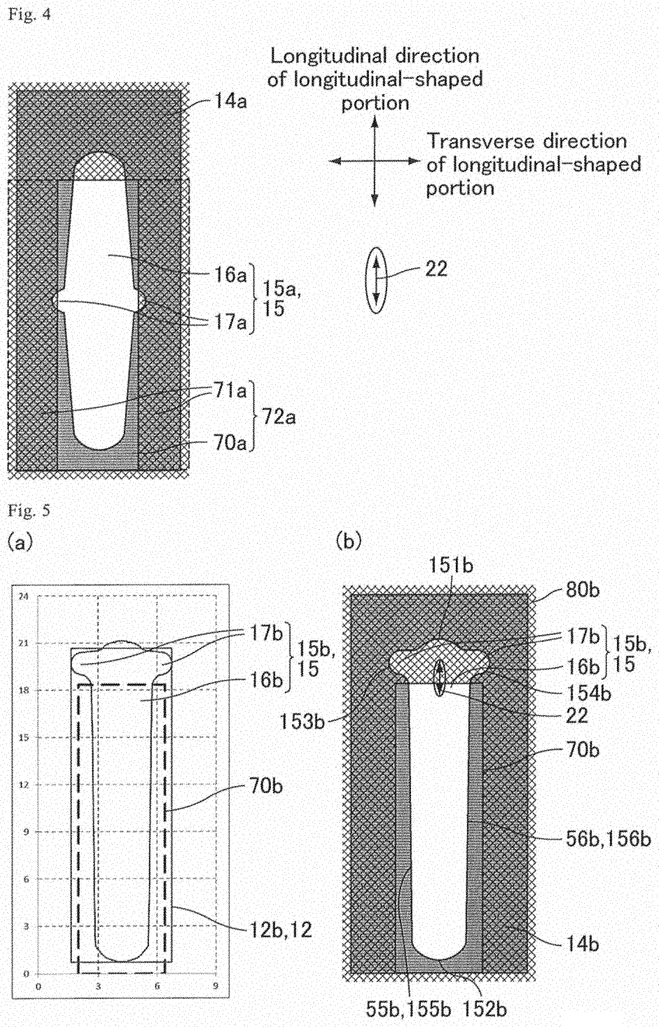

FIG. 4 is a schematic plan view illustrating the opening shape of the high-speed display unit in the liquid crystal display device according to the embodiment of the present invention. As shown in FIG. 4, in a plan view, the pair of protrusions 17a of the high-speed display unit 50a are located within a region 72a including the light-transmitting region 70a and a region 71a obtained by virtually expanding the light-transmitting region 70a in the transverse direction (the direction orthogonal to the initial alignment azimuth 22 of liquid crystal molecules) of the longitudinal-shaped portion 16a, thereby forming the four liquid crystal domains 23a in the light-transmitting region 70a for one opening 15a in the voltage-applied state.

Cross-shaped dark lines (a region in which the liquid crystal molecules 21 do not move) exist at the center of the four liquid crystal domains 23a, and it is considered that the liquid crystal molecules 21 which do not move serve as walls for generating a force in a direction opposite to the rotational direction of the four liquid crystal domains 23a to improve the response speed. In the high-speed display unit 50a, the response speed can be further improved by increasing the symmetry of the four liquid crystal domains 23a.

In this case, the pair of protrusions 17a of the high-speed display unit 50a are located in the region 72a combining the light-transmitting region 70a and the region 71a obtained by virtually expanding the light-transmitting region 70a in the transverse direction of the longitudinal-shaped portion 16a. This arrangement includes a case in which the pair of protrusions 17a are entirely included inside the region 72a.

Even in a case in which part of the pair of protrusions 17a is slightly included outside the region 72a, when the four liquid crystal domains are generated in the light-transmitting region 70a in the voltage-applied state, the pair of protrusions 17a are regarded to be located inside the region 72a.

The initial alignment azimuth 22 of the liquid crystal molecules parallel to the longitudinal direction of the longitudinal-shaped portion 16a can be achieved by subjecting the alignment film to photo alignment treatment or rubbing treatment in the transverse direction of the longitudinal-shaped portion 16a. The initial alignment azimuth 22 of the liquid crystal molecules orthogonal to the longitudinal direction of the longitudinal-shaped portion 16a can be achieved by subjecting the alignment film to photo alignment treatment or rubbing treatment in the longitudinal direction of the longitudinal-shaped portion 16b.

In the case of using an opening formed only with a longitudinal-shaped portion not including a pair of protrusions, although it is possible to form four liquid crystal domains, symmetry around the center of the dark lines collapses, and the dark lines cannot be fixed, so that a region in which liquid crystal molecules tend to rotate and a region in which liquid crystal molecules are hard to rotate are formed. It is considered that, in the region in which liquid crystal molecules tend to rotate, liquid crystal molecules continue to rotate more than necessary, resulting in a slow response speed. On the other hand, as in the liquid crystal display device 1 according to the present embodiment, arranging the pair of protrusions 17a on the longitudinal-shaped portion 16a generates an electric field 18a in an oblique direction near the pair of protrusions 17a and stabilizes the alignment of liquid crystal molecules 211B in the voltage-applied state, thereby fixing the dark lines. As a result, it is considered that the response speed can be improved.

Further, it is considered that, when the pair of protrusions 17a is provided at the center in the longitudinal direction of the longitudinal-shaped portion 16a, because the four liquid crystal domains 23a are generated in the four regions symmetrical (substantially symmetrical) with respect to the longitudinal direction and the transverse direction of the longitudinal-shaped portion 16a, the response speed can be further improved. From such a viewpoint, it is preferable that the shape of the opening 15a of the counter electrode 14a is symmetrical with respect to the initial alignment azimuth 22 of liquid crystal molecules, and it is preferable that the shape of the opening 15a is symmetrical with respect to the longitudinal direction and the transverse direction of the longitudinal-shaped portion 16a.

The longitudinal-shaped portion 16a is an opening portion formed in a longitudinal shape having a longitudinal length larger than the width in the transverse direction, and examples of the longitudinal shape include an ellipse; a shape similar to an ellipse such as an egg shape; a long polygon such as a rectangle; a shape similar to a long polygon; and a shape in which at least one corner of a long polygon is rounded. Although both the end portions of the longitudinal-shaped portion 16a are not necessarily rounded, it is preferable that at least one of the end portions is rounded, and it is more preferable that both the end portions are rounded. When at least one end portion of the longitudinal-shaped portion 16a is rounded, the alignment of the liquid crystal molecules 21 is fixed by the electric field in the oblique direction at this end portion, and the response speed can be further improved.

The pair of protrusions 17a protrude to opposite sides (outside, transverse direction) from the longitudinal-shaped portion 16a, and are provided at opposite edge portions of an intermediate portion of the longitudinal-shaped portion 16a. Each of the protrusions 17a may largely protrude from the longitudinal-shaped portion 16a or may only slightly protrude, and the size of each of the protrusions 17a is not limited. Each of the protrusions 17a only needs to protrude from the longitudinal-shaped portion 16a, and its outer edge may be a circular-arc shape or an elliptical arc shape, may be curved, or may have irregularities. Further, each of the protrusions 17a may be shaped into a polygon such as a triangle or a trapezoid (however, a trapezoid whose longer base is adjacent to the longitudinal-shaped portion 16a) or a shape in which at least one corner of such a polygon is rounded.

The pair of protrusions 17a are provided at positions corresponding to each other at the intermediate portion of the longitudinal-shaped portion 16a, and although the pair of protrusions 16a may be provided at positions close to one end portion of the longitudinal-shaped portion 16a, the pair of protrusions 17a are preferably provided at the center in the longitudinal direction of the longitudinal-shaped portion 16a. By providing the pair of protrusions 17a at the center in the longitudinal direction of the longitudinal-shaped portion 16a, it is possible to align and divide the liquid crystal molecules 21 into four substantially symmetrical regions in the voltage-applied state, so that the response speed can be further improved.

In the high-speed display unit 50a, by shifting the positions of the pair of protrusions 17a from the central portion of the longitudinal-shaped portion 16a in the longitudinal direction to the end portion side and lowering the symmetry of the shape of the opening 15a, the response speed is reduced, but the transmittance is not changed much.

The pair of protrusions 17a are preferably provided opposite to each other, preferably provided at substantially the same position in the longitudinal direction of the longitudinal-shaped portion 16a, and preferably provided at positions symmetrical with respect to the longitudinal direction of the longitudinal-shaped portion 16a.

The pair of protrusions 17a may be provided at part of the intermediate portion or may be provided over the entire intermediate portion. By adjusting the position and size of the pair of protrusions 17a, it becomes possible to balance cross-shaped dark lines generated at the center of the display unit in the voltage-applied state, and to stabilize the alignment of the liquid crystal molecules 21.

When both end portions of the longitudinal-shaped portion 16a in the longitudinal direction are respectively defined as an upper end portion 151a and a lower end portion 152a, and both end portions of the pair of protrusions 17a are respectively defined as a left end portion 153a and a right end portion 154a, the contour of the opening 15a preferably includes, in a plan view, a first inclined contour 155a along a first line segment 55a extending from the upper end portion 151a to the right end portion 154a of the opening 15a, a second inclined contour 156a along a second line segment 56a extending from the upper end portion 151a to the left end portion 153a of the opening 15a, a third inclined contour 157a along a third line segment 57a extending from the lower end portion 152a of the opening 15a to the left end portion 153a, and a fourth inclined contour 158a along a fourth line segment 58a extending from the lower end portion 152a to the right end portion 154a. In a plan view, the first, second, third, and fourth line segments 55a to 58a each are preferably inclined with respect to the initial alignment azimuth 22 of liquid crystal molecules. When such an aspect is adopted, the liquid crystal molecules 21 easily rotate upon application of a voltage, thus further increasing the response speed. “The first to fourth inclined contours 155a to 158a extend along the first to fourth line segments 55a to 58a” means that the first to fourth inclined contours 155a to 158a respectively coincide with the first to fourth line segments 55a to 58a or the first to fourth inclined contours 155a to 158a parallelly move (translate) along the first to fourth line segments 55a to 58a, respectively, and both may be parallel to each other or may not be parallel in the range in which the effect of the present invention can be obtained. In the latter case, the inclined contour may be curved or may include a linear portion that is not parallel to the line segment.

A high-luminance display unit will be described next. The high-luminance display unit has the same configuration as that of the high-speed display unit 50a except that the positions of the pair of protrusions are different.

FIG. 5 is a view relating to a high-luminance display unit in the liquid crystal display device according to the embodiment of the present invention, in which (a) is a plan view of an opening shape provided in a counter electrode and (b) is a schematic plan view of a counter electrode. FIG. 6 is a view relating to a high-luminance display unit in the liquid crystal display device according to the embodiment of the present invention, in which (a) is a schematic view for explaining alignment control of liquid crystal molecules in the voltage-applied state, (b) is an enlarged plan view showing a simulation result of the alignment distribution of liquid crystal molecules in the voltage-applied state, and (c) is a plan view showing a simulation result of the alignment distribution of liquid crystal molecules in the voltage-applied state. FIG. 6(b) is a simulation result of a region B surrounded by the dotted line in FIG. 6(a).

As shown in FIGS. 5 and 6, a high-luminance display unit 50b has a light-transmitting region 70b and a light-blocking region 80b surrounding the periphery of the light-transmitting region 70b in a plan view. In a voltage-applied state, two liquid crystal domains 23b are generated in the light-transmitting region 70b for one opening 15b. The light-transmitting region 70b is a region that can transmit light. This region transmits and blocks light by changing the voltage applied between a counter electrode 14b and a pixel electrode 12b so as to rotate the liquid crystal molecules 21, thereby adjusting white display, halftone display, and black display. The light-blocking region 80b is a region that blocks light and is a region that always displays black, because a light blocking member such as a black matrix is disposed.

The counter electrode 14b in the high-luminance display unit 50b is formed with an opening 15b including a longitudinal-shaped portion 16b and a pair of protrusions 17b protruding to opposite sides from the longitudinal-shaped portion 16b. The light-transmitting region 70b may overlap at least part of the longitudinal-shaped portion 16b. However, from the viewpoint of further increasing the transmittance, it is preferable that the light-transmitting region 70b overlaps substantially the entire longitudinal-shaped portion 16b and overlaps the region excluding one end portion of the longitudinal-shaped portion 16b.

The longitudinal direction of the longitudinal-shaped portion 16b is parallel to the alignment azimuth of liquid crystal molecules 212A in a no-voltage-applied state (the initial alignment azimuth 22 of liquid crystal molecules). In the high-speed display unit 50a, the pair of protrusions 17a are present at the center in the longitudinal direction of the longitudinal-shaped portion 16a. In contrast to this, in the high-luminance display unit 50b, the pair of protrusions 17b are provided adjacent to one of the end portions of the longitudinal-shaped portion 16b in the longitudinal direction and are located places corresponding to each other. In addition, the pixel electrode 12b is provided so as to overlap substantially the entire opening 15b. Since the opening 15b is used for forming a fringe electric field (oblique electric field) and does not include a complicated shape, the opening 15b can be applied to ultrahigh-definition pixels of not less than 800 ppi, for example, without any problem.

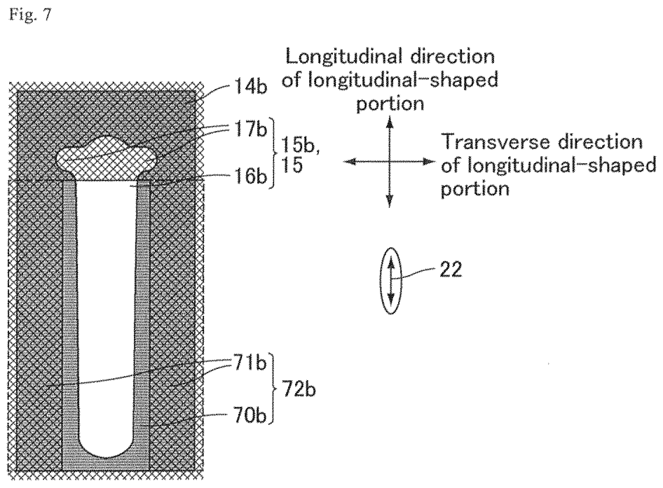

FIG. 7 is a schematic plan view illustrating the opening shape of a high-luminance display unit in the liquid crystal display device according to the embodiment of the present invention. As shown in FIG. 7, in a plan view, the pair of protrusions 17b of the high-luminance display unit 50b are located outside a region 72b combining the light-transmitting region 70b and a region 71b obtained by virtually expanding the light-transmitting region 70b in the transverse direction of the longitudinal-shaped portion 16b (the direction orthogonal to the initial alignment azimuth 22 of the liquid crystal molecules).

By adopting such an opening shape, the four liquid crystal domains 23b are generated in the voltage-applied state, and the two liquid crystal domains 23b among them are arranged in the light-blocking region 80b, thereby hiding part of a disclination, which serves as dark lines in the light-transmitting region 70b, in the light-blocking region 80b. As a result, the transmittance of the high-luminance display unit 50b can be improved.

Because the four liquid crystal domains 23b are generated in the high-luminance display unit 50b, it is possible to improve the response speed as compared with Comparative Embodiment 1 described above. However, in the two liquid crystal domains 23b located in the light-transmitting region 70b, the distance from the pair of protrusions 17b to the end portion of the opening 15b in the longitudinal direction is large and the distortion of the bend alignment of the liquid crystal molecules 21 is small. For this reason, the response speed does not improve as much as in the high-speed display unit 50a.

In this case, the pair of protrusions 17b of the high-luminance display unit 50b are located outside the region 72b combining the light-transmitting region 70b and the region 71b obtained by virtually expanding the light-transmitting region 70b in the transverse direction of the longitudinal-shaped portion 16b. This arrangement includes a case in which the pair of protrusions 17b are entirely included outside the region 72b.

Even in a case in which part of the pair of protrusions 17b is slightly included inside the region 72b, when the two liquid crystal domains 23b are generated in the light-transmitting region 70b in the voltage-applied state, the pair of protrusions 17b are regarded to be located outside the region 72b.

The initial alignment azimuth 22 of liquid crystal molecules parallel to the longitudinal direction of the longitudinal-shaped portion 16b can be achieved by subjecting the alignment film to photo alignment treatment or rubbing treatment in the transverse direction of the longitudinal-shaped portion 16b. The initial alignment azimuth 22 of the liquid crystal molecules orthogonal to the longitudinal direction of the longitudinal-shaped portion 16b can be achieved by subjecting the alignment film to photo alignment treatment or rubbing treatment in the longitudinal direction of the longitudinal-shaped portion 16b.

In the high-luminance display unit 50b, as in the high-speed display unit 50a, by arranging the pair of protrusions 17b on the longitudinal-shaped portion 16b, an electric field 18b in an oblique direction is generated near the pair of protrusions 17b, and the alignment of the liquid crystal molecules 2128 is stabilized in the voltage-applied state, so that the disclination (dark lines) can be fixed. As a result, it is considered that the response speed can be improved. From the viewpoint of further improving the response speed, it is preferable that the shape of the opening 15b of the counter electrode 14b is symmetrical with respect to the initial alignment azimuth 22 of the liquid crystal molecules.

The longitudinal-shaped portion 16b is an opening portion formed in a longitudinal shape having a longitudinal length larger than the width in the transverse direction, and examples of the longitudinal shape include an ellipse; a shape similar to an ellipse such as an egg shape; a long polygon such as a rectangle; a shape similar to a long polygon; and a shape in which at least one corner of a long polygon is rounded. Although both the end portions of the longitudinal-shaped portion 16b are not necessarily rounded, it is preferable that at least one of the end portions is rounded, and it is more preferable that both the end portions are rounded. When at least one end portion of the longitudinal-shaped portion 16b is rounded, the alignment of the liquid crystal molecules is fixed by the electric field in the oblique direction at this end portion, and the response speed can be further improved.

The pair of protrusions 17b protrude to opposite sides from the longitudinal-shaped portion 16b (outside; transverse direction) and are provided at opposite edge portions located adjacent to the two sides of one end portion of the longitudinal-shaped portion 16b. Each of the protrusions 17b may largely or slightly protrude from the longitudinal-shaped portion 16b, and the size of each of the protrusions 17b is not limited. Each of the protrusions 17b only needs to protrude from the longitudinal-shaped portion 16b, and its outer edge may be a circular-arc shape or an elliptical arc shape, may be curved, or may have irregularities. Further, each of the protrusions 17b may be shaped into a polygon such as a triangle or a trapezoid (however, a trapezoid whose longer base is adjacent to the longitudinal-shaped portion 16b) or a shape obtained by rounding at least one corner of such a polygon.

The pair of protrusions 17b may be provided at positions corresponding to each other at the middle portion or the central portion of the longitudinal-shaped portion 16b. However, from the viewpoint of ensuring the light-transmitting region 70b as large as possible, it is preferable to make the two liquid crystal domains 23b generated in the light-transmitting region 70b larger than the two liquid crystal domains 23b generated in the light-blocking region 80b. Accordingly, as described above, the two liquid crystal domains 23b are preferably provided adjacent to both sides of one end portion of the longitudinal-shaped portion 16b.

In the high-luminance display unit 50b, the luminance is lowered when the positions of the pair of protrusions 17b are shifted from one end portion of the longitudinal-shaped portion 16b to the center side in the longitudinal direction, but the response speed is further improved in the high-luminance display unit 50b. It is possible to implement a liquid crystal display device configured to suppress the occurrence of a region in which the response speed and the luminance abruptly change and to achieve gradation without unevenness by disposing such an intermediate improvement pattern between the high-speed display unit 50a and the high-luminance display unit 50b, in which the pair of protrusions 17b are located closer to an end portion of the longitudinal-shaped portion 16b in the longitudinal direction.

The pair of protrusions 17b are preferably provided opposite to each other, preferably provided at substantially the same position in the longitudinal direction of the longitudinal-shaped portion 16b, and preferably provided at positions symmetrical with respect to the longitudinal direction of the longitudinal-shaped portion 16b.

When both end portions of the longitudinal-shaped portion 16b in the longitudinal direction are respectively defined as an upper end portion 151b and a lower end portion 152b, and both end portions of the pair of protrusions 17b are respectively defined as a left end portion 153b and a right end portion 154b, the contour of the opening 15b preferably includes, in a plan view, a first inclined contour 155b along a first line segment 55b extending from the lower end portion 152b to the left end portion 153b of the opening 15b, and a second inclined contour 156b along a second line segment 56b extending from the lower end portion 152b to the right end portion 154b of the opening 15b. In a plan view, the first and second line segments 55b and 56b each are preferably inclined with respect to the initial alignment azimuth 22 of liquid crystal molecules. When such an aspect is adopted, the liquid crystal molecules 21 easily rotate upon application of a voltage, thus further increasing the response speed. “The first and second inclined contours 155b and 156b extend along the first and second line segments 55b and 56b” means that the first and second inclined contours 155b and 156b respectively coincide with the first and second line segments 55b and 56b or the first and second inclined contours 155b and 156b parallelly move (translate) along the first and second line segments 55b and 56b, respectively, and both may be parallel to each other or may not be parallel in the range in which the effect of the present invention can be obtained. In the latter case, the inclined contour may be curved or may include a linear portion that is not parallel to the line segment. Even in the high-luminance display unit 50b, like the high-speed display unit 50a, inclined contours may be respectively provided between the contour of the upper end portion 151b and the left end portion 153b and the right end portion 154b.

In the liquid crystal display device 1, a data signal is written in the high-speed display unit 50a later than in the high-luminance display unit 50b within one frame period, so that as described above, it is possible to implement bright display in at least part of the display region, as described above, and to obtain an image in which image blurring is suppressed. The arrangement of the high-speed display unit 50a and the high-luminance display unit 50b will be described below while the configuration of the liquid crystal display device 1 is shown.

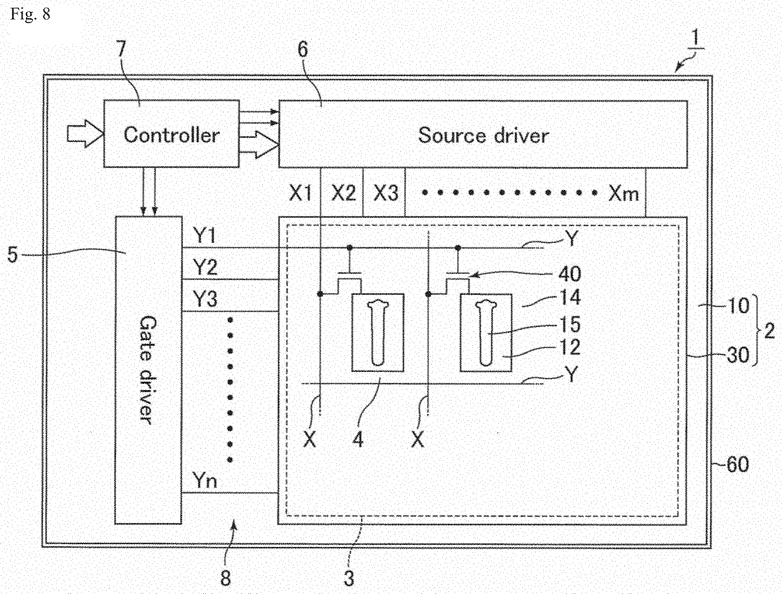

FIG. 8 is a schematic plan view showing the configuration of the liquid crystal display device according to the embodiment of the present invention. As shown in FIG. 8, the liquid crystal display device 1 is an active matrix drive type and transmission type liquid crystal display device, and includes a liquid crystal panel 2. The liquid crystal panel 2 has a display region 3 for displaying an image, and the display region 3 is constituted by display units 4 arranged in a matrix of m×n. In addition, one pixel is composed of multiple display units 4 (for example, three display units; red, green, and blue) (that is, sub pixels).

On the first substrate 10, in the display region 3, m×n pixel electrodes 12 arranged for each display unit 4 are formed, together with n gate signal lines Y (Y1, Y2, Y3, . . . , Yn) each extending in the row direction, m source signal lines X (X1, X2, X3, . . . , Xm) each extending in the column direction, m×n switching elements arranged near the intersections of the source signal lines X and the gate signal lines Y in each display unit 4, and the counter electrode 14 which supplies a signal common to all the display units 4 (common signal). Each switching element is composed of a thin-film transistor (TFT) 40, for example. In the liquid crystal display device 1, the gate signal line Y is provided for each row of the display unit and the source signal line X is provided for each column of the display unit. However, the gate signal line Y may be provided for each column of the display unit, The source signal line X may be provided for each row of the display unit.

The first substrate 10 further includes at least part of a gate driver 5 electrically connected to the gate signal line Y and at least part of a source driver 6 electrically connected to the source signal line X in a drive circuit region 8 around the display region 3. The gate driver 5 sequentially supplies scanning signals (driving signals) to the n gate signal lines Y under the control of a controller 7. For example, within one frame period, scanning signals are sequentially supplied to all the gate signal lines Y in the display region 3 from the gate signal lines Y1 to Yn. Such line sequential scanning in a predetermined direction is also called gate scanning. Line sequential scanning in the liquid crystal display device 1 is normally performed from one end portion of the liquid crystal panel 2 toward the other end portion as described above. However, scanning may be made from the center of the liquid crystal panel toward both end portions or may be made from both end portions of the liquid crystal panel toward the center.

Gate scanning starts from the beginning of one frame period and ends at the end of one frame period at the latest. Gate scanning normally ends at an earlier stage than the end of one frame period. For example, gate scanning may be started with the start of one frame period and may be ended after the lapse of a period of ⅔ to ⅘ of one frame period.

The source driver 6 supplies data signals (drive signals) to the m source signal lines X under the control of the controller 7 at the timing at which the switching elements of each row are set in the voltage-applied state by a scanning signal. As a result, the pixel electrodes 12 on each row each are set to a potential corresponding to the data signal supplied via the corresponding switching element, and the plurality of display units 4 are individually and independently driven.

In this way, in the voltage-applied state, a data signal is applied to the lower layer pixel electrode 12 via a TFT 40, and a fringe electric field is generated between the counter electrode 14 formed on the upper layer via the insulating film 13 and the pixel electrode 12. The TFT 40 preferably has a channel formed from indium-gallium-zinc-oxygen (IGZO), which is an oxide semiconductor.

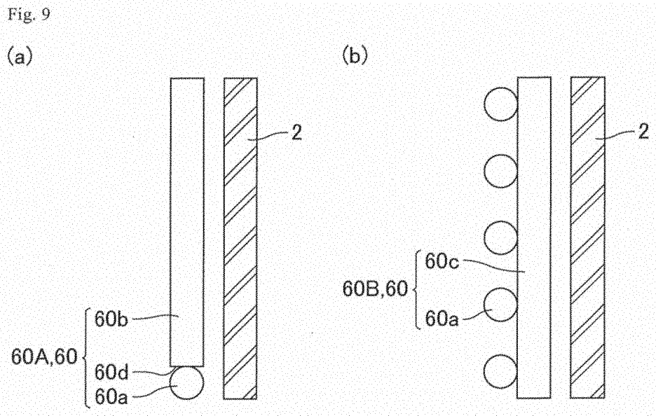

FIG. 9 is a schematic cross-sectional view showing the configurations of the backlights of the liquid crystal display devices according to the embodiment of the present invention, in which (a) is a schematic cross-sectional view of a liquid crystal display device having an edge-light type backlight, and (b) is a schematic cross-sectional view of a liquid crystal display device having a direct type backlight.

The liquid crystal display device 1 includes the backlight 60 that emits light to the liquid crystal panel 2. The backlight 60 is not particularly limited as long as it emits light including visible light, and may emit light including only visible light, or may emit light including both visible light and ultraviolet light. In order to enable color display by the liquid crystal display device 1, it is preferable that the backlight 60 emits white light.

The backlight 60 is disposed behind the liquid crystal panel 2. The liquid crystal display device 1 normally uses an edge-light type backlight 60A, but may use a direct type backlight 60B.

As shown in FIG. 9(a), the edge-light type backlight 60A includes a light source 60a, a light guide plate 60b, and an optical sheet (not shown) such as a diffusion sheet disposed on the liquid crystal panel 2 side of the light guide plate 60b. The light guide plate 60b is disposed to face the first substrate 10 (or the second substrate 30) of the liquid crystal panel 2. The light source 60a is disposed to face a side surface of the light guide plate 60b and irradiates the side surface of the light guide plate 60b with light. The light emitted from the light source 60a is converted into planar light by internal reflection of the light guide plate 60b and exits from the surface of the light guide plate 60b which is located on the liquid crystal panel 2 side. The liquid crystal panel 2 is then irradiated with this light via the optical sheet. The side surface of the light guide plate on which light from the light source 60a is incident is also referred to as a light incident surface 60d.

As shown in FIG. 9(b), the direct type backlight 60B includes a light source 60a, a diffusion plate 60c, and an optical sheet (not shown) such as a diffusion sheet disposed on the liquid crystal panel 2 side of the diffusion plate 60c. The light source 60a is disposed on substantially the entire rear surface of the liquid crystal panel 2, and the liquid crystal panel 2, the optical sheet, the diffusion plate 60c, and the light source 60a are arranged in the given order from the viewer side. The light emitted from the light source 60a is converted into planar light by the diffusion of the diffusion plate 60c. The liquid crystal panel 2 is then irradiated with this light via the optical sheet.

Examples of the light source 60a include a light emitting diode (LED) and a cold cathode tube. It is preferable to use an LED. The light guide plate 60b and the diffusion plate 60c are made of organic materials such as polycarbonate and acrylic resin.

The light source 60a preferably lights up for a predetermined time in one frame period and preferably starts lighting at a later time than when the high-speed display unit 50a is driven, and more preferably starts lighting at a later time than when the high-speed display unit 50a connected to the gate signal line Y of the final stage is driven. By adopting such an aspect, lighting can be performed in a state in which the response of the liquid crystal molecules 21 has further advanced, so that image blurring can be further suppressed. Further, it is preferable that the light source 60a lights up until the end of one frame period. By adopting such an aspect, a brighter image can be obtained.

The lighting time of the light source 60a is preferably 30% or less of one frame period, more preferably 5% or more and 15% or less of one frame period.

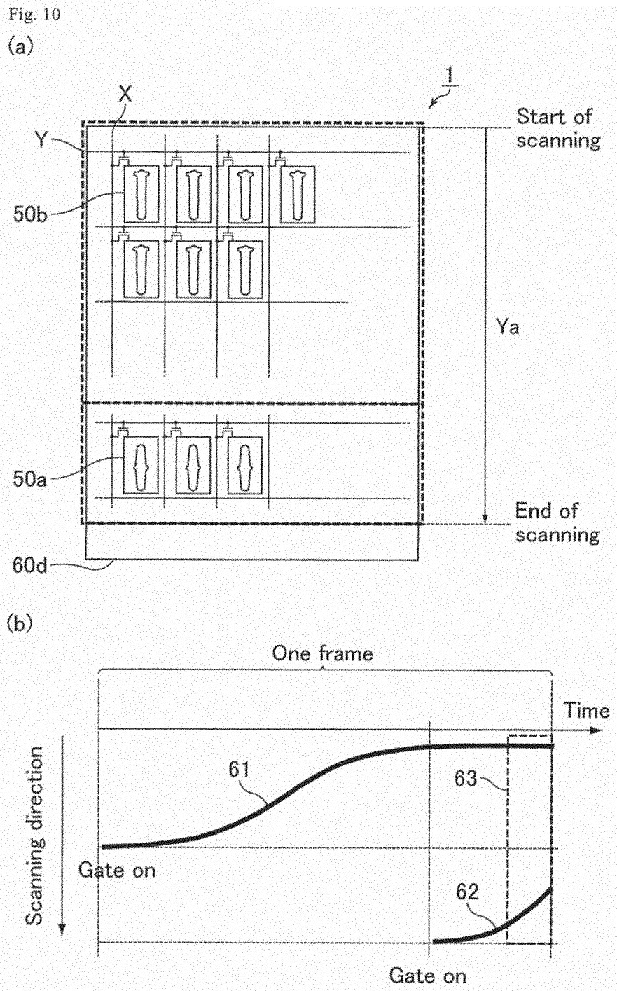

FIG. 10 is a view relating to the liquid crystal display device according to the embodiment of the present invention, in which (a) is a schematic plan view showing the arrangement of each display unit, and (b) is a schematic view showing luminance curves in a high-luminance display unit and a high-speed display unit. In the liquid crystal display device 1, scanning signals are sequentially supplied to the gate signal lines Y along a gate scanning direction Ya shown in FIG. 10(a) from the upper portion to the lower portion in FIG. 10(a).

The liquid crystal display device 1 writes a data signal in the high-speed display unit 50a within one frame period later than in the high-luminance display unit 50b. That is, the high-luminance display unit 50b and the high-speed display unit 50a are arranged along the gate scanning direction Ya in this order toward the light incident surface 60d. In other words, the high-speed display unit 50a is located at an end portion of the display region, and the high-luminance display unit 50b is located at the other portion of the display region which includes the central portion of the display region.

The relationship between the operation of the liquid crystal molecules 21 and the luminance of the display unit in each of the high-speed display unit 50a and the high-luminance display unit 50b will be described. In the high-luminance display unit 50b, a data signal is written at a stage earlier than in the high-speed display unit 50a. Therefore, as indicated by a luminance curve 61 of the high-luminance display unit in FIG. 10(b), because the liquid crystal molecules 21 can sufficiently respond near the end of one frame, high luminance can be obtained in the period 63 during which the backlight lights up.

On the other hand, a data signal is written in the high-speed display unit 50a later than in the high-luminance display unit 50b. However, in the high-speed display unit 50a, the liquid crystal molecules 21 respond quickly as compared with the high-luminance display unit 50b, and hence the liquid crystal molecules 21 sufficiently respond within one frame and sufficient luminance is obtained in the period 63 in which the backlight lights up, as indicated by a luminance curve 62 of the high-speed display unit in FIG. 10(b). Referring to FIG. 10(b), a data signal is written at the time of “gate ON”.

The high-speed display unit 50a in the liquid crystal display device 1 is preferably connected to any of multiple successive gate signal lines Y including the gate signal line Yn of the final stage, and the display unit connected to a given gate signal line of the n1th stage to the gate signal line Yn of the nth stage among n gate signal lines Y1 to Yn is more preferably the high-speed display unit 50a. However, n1 is preferably an integer satisfying n×⅔≤n1≤n, and more preferably an integer satisfying n×¾≤n 1≤n.

The high-luminance display unit 50b in the liquid crystal display device 1 is preferably connected to any of multiple successive gate signal lines Y including the gate signal line Y1 of the first stage, and the display unit connected to a gate signal line Y1 of the first stage to a given gate signal line of the n2th stage among n gate signal lines Y1 to Yn is more preferably the high-luminance display unit 50b. However, n2 is preferably an integer satisfying 1≤n2<n×⅔, and more preferably an integer satisfying 1≤n2<n×¾ from the viewpoint of gradation adjustment.

The backlight 60 preferably has luminance that changes in accordance with the arrangement of the high-speed display unit 50a and the high-luminance display unit 50b, and the luminance in a region facing the high-speed display unit 50a is preferably higher than that in a region facing the high-luminance display unit 50b. Changing the luminance distribution of the backlight 60 in this manner can compensate for a decrease in luminance in the high-speed display unit 50a with the luminance of the backlight 60 and obtain a uniform image over the entire surface of the display region 3. The edge-light type backlight 60A can control the luminance distribution in the plane (within the light-emitting surface) of the liquid crystal panel 2, for example, by adjusting the shape of the light guide plate 60b. The direct type backlight 60B can control the luminance distribution in the plane (within the light-emitting surface) of the liquid crystal panel 2, for example, by adjusting the amount of light emitted from the light source 60a disposed below the diffusion plate 60c.

In the liquid crystal display device 1, it is preferable that the high-speed display unit 50a is located closer to the light incident surface 60d of the light guide plate 60b than the high-luminance display unit 50b. By adopting such an aspect, it is possible to easily increase the luminance of the backlight 60 in a region facing the high-speed display unit 50a with insufficient luminance, and it is easy to obtain a bright image on the entire surface of the display region 3.

As Modification 1 of the liquid crystal display device 1, there is presented an aspect in which multiple light sources 60a are arranged along the display unit 4 connected to the source signal line X1 and/or the display unit 4 connected to the source signal line Xm, and the light source 60a on a side of the high-speed display unit 50a is caused to emit light with high luminance. By adopting such an aspect, it is possible to easily increase the luminance of the backlight 60 in a region facing the high-speed display unit 50a with insufficient luminance.

As Modification 2 of the liquid crystal display device 1, there is presented an aspect in which the high-speed display unit 50a is disposed on the end face side opposite to the light incident surface 60d. Adopting such an aspect makes it possible to easily increase the luminance of the backlight 60 in a region facing the high-speed display unit 50a with insufficient luminance by using light reflected by the side surface opposite to the light incident surface 60d.

Members common to the high-speed display unit 50a and the high-luminance display unit 50b will be described below.

The pixel electrode 12 is a planar electrode without opening. The pixel electrode 12 and the counter electrode 14 are stacked with the insulating layer 13 interposed therebetween. As shown in FIG. 8, in a plan view, each pixel electrode 12 is positioned under the corresponding opening 15 in the counter electrode 14. Thus, a fringe electric field is generated around the openings 15 in the counter electrode 14 when a potential difference is generated between the pixel electrodes 12 and the counter electrode 14. As shown in FIG. 8, the openings 15 in the counter electrode 14 are preferably arranged in line in the row direction and/or the column direction in adjacent display units 4. This arrangement can stabilize the alignment of the liquid crystal molecules 21 in the voltage-applied state.

As the insulating layer 13 provided between the pixel electrode 12 and the counter electrode 14, for example, an organic film (dielectric constant ε=3 to 4), an inorganic film (dielectric constant ε=5 to 7) such as silicon nitride (SiNx) film, silicon oxide (SiO2) film, or a multilayer film containing these films can be used.

The liquid crystal molecules 21 may have negative or positive value for the anisotropy of dielectric constant (As) defined by the formula below. That is, the liquid crystal molecules 21 may have negative anisotropy of dielectric constant or positive anisotropy of dielectric constant. Since the liquid crystal materials containing the liquid crystal molecules 21 having negative anisotropy of dielectric constant tend to have a relatively high viscosity, from the viewpoint of obtaining high-speed response performance, liquid crystal materials containing the liquid crystal molecules 21 having positive anisotropy of dielectric constant are advantageous. However, even with a liquid crystal material having negative anisotropy of dielectric constant, if this liquid crystal material has a viscosity as low as that of a liquid crystal material having positive anisotropy of dielectric constant, the same effect can be obtained by means of the present embodiment. The initial alignment azimuth 22 of the liquid crystal molecules 21 having negative anisotropy of dielectric constant is a direction of rotation by 90 degrees with respect to the liquid crystal molecules 21 having positive anisotropy of dielectric constant.

Δε=(dielectric constant in the major axis direction)−(dielectric constant in the minor axis direction)

From the viewpoint of high speed and high transmittance, when the liquid crystal molecules 21 having positive anisotropy of dielectric constant are used, it is preferable that the initial alignment azimuth 22 of the liquid crystal molecules 21 in a plan view is parallel to the longitudinal direction of the longitudinal-shaped portions 16a and 16b, and when the liquid crystal molecules 21 having negative anisotropy of dielectric constant are used, it is preferable that the initial alignment azimuth 22 of liquid crystal molecules in a plan view is orthogonal to the longitudinal direction of the longitudinal-shaped portions 16a and 16b. On the other hand, in a plan view, when the initial alignment azimuth 22 of liquid crystal molecules having positive anisotropy of dielectric constant is made orthogonal to the longitudinal direction of the longitudinal-shaped portions 16a and 16b, or when the initial alignment azimuth 22 of the liquid crystal molecules having negative anisotropy of dielectric constant is made parallel to the longitudinal direction of the longitudinal-shaped portions 16a and 16b, although the effect of speeding up is provided, the effect is not large, and the transmittance is extremely lowered.

In a plan view, the alignment azimuth of the liquid crystal molecules 21 in the no-voltage-applied state is parallel to the absorption axis of one of the first polarizer and the second polarizer, and orthogonal to the absorption axis of the other. The control mode of the liquid crystal display device 1 is thus what is called a normally black mode, which provides black display when the liquid crystal layer 20 is in the no-voltage-applied state.

The second substrate 30 is not particularly limited, and a color filter substrate generally used in the field of liquid crystal display devices can be used. The overcoat layer 33 smooths the surface of the second substrate 30 which is located on the liquid crystal layer 20 side, and for example, an organic film (dielectric constant ε=3 to 4) can be used.

Usually, the first substrate 10 and the second substrate 30 are bonded together with a sealing material provided so as to surround the liquid crystal layer 20, and the liquid crystal layer 20 is held by the first substrate 10, the second substrate 30, and the sealing material in a predetermined region. Examples of the sealing material include epoxy resins containing an inorganic or organic filler and a curing agent.

The liquid crystal display device 1 may include optical films such as a retardation film, a viewing angle-increasing film, and a luminance-increasing film, external circuits such as a tape-carrier package (TCP) and a printed circuit board (PCB), and members such as a bezel (frame), in addition to the first substrate 10, liquid crystal layer 20, and second substrate 30. These components are not limited, and may be those usually used in the field of liquid crystal display devices. The description of these components is thus omitted.

The operation of the liquid crystal display device 1 will be described hereinbelow.

In the liquid crystal layer 20 in the no-voltage-applied state, no electric field is generated, and the liquid crystal molecules 21 are aligned parallel to the first substrate 10. Since the alignment azimuth of the liquid crystal molecules 21 is parallel to the absorption axis of one of the first polarizer and the second polarizer, and since the first polarizer and the second polarizer are disposed in the crossed Nicols, the liquid crystal panel 2 in the no-voltage-applied state does not transmit light and provides black display.

FIG. 1 shows the voltage-applied state, where a voltage is applied between the pixel electrode 12 and the counter electrode 14. In the liquid crystal layer 20 in the voltage-applied state, an electric field according to the level of the voltage between the pixel electrode 12 and the counter electrode 14 is generated. Specifically, since the opening 15 is formed in the counter electrode 14 provided closer to the liquid crystal layer 20 than the pixel electrode 12, a fringe electric field is generated around the opening 15. The liquid crystal molecules 21 rotate under the effect of the electric field and change their alignment azimuth from the alignment azimuth (FIG. 3) in the no-voltage-applied state to the alignment azimuth in the voltage-applied state. The liquid crystal panel 2 in the voltage-applied state thus transmits light to provide white display.

The alignment mode of the liquid crystal display device 1 is a fringe field switching (FFS) mode, and is particularly preferably used for a display typified by a head mount display (HMD) or the like mounted on the user's head. These displays preferably have a virtual reality function. By suppressing image blurring by using the liquid crystal display device 1 as a display such as HMD, it is possible to suppress motion sickness.

Results of simulation concerning various high-speed display units and high-luminance display units will be described below.

### (High-Luminance Display Unit A-1)

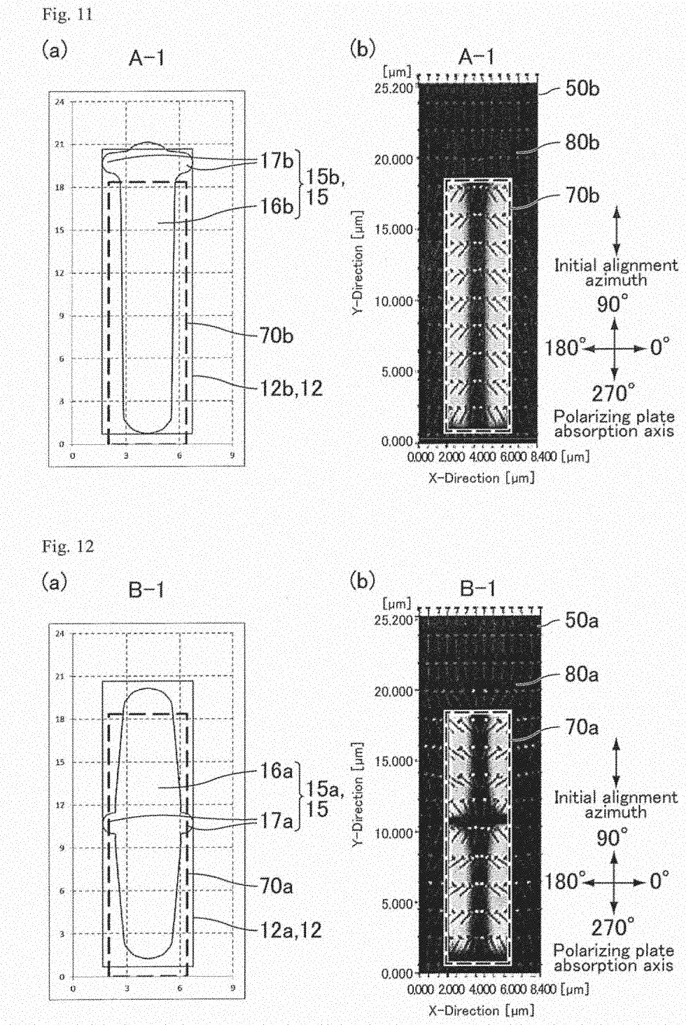

FIG. 11 is a view relating to a high-luminance display unit A-1, in which (a) is a plan view showing the opening shape of a counter electrode, and (b) is a plan view showing the simulation result of the alignment distribution of liquid crystal molecules in the voltage-applied state.

For the counter electrode 14b in a high-luminance display unit A-1, the opening 15b is cut out along the shape of the solid line in FIG. 11(a).

For the liquid crystal layer 20, the refractive index anisotropy (Δn) is set to 0.11, the in-plane retardation (Re) is set to 310 nm, and the viscosity is set to 70 cps. In addition, the anisotropy of dielectric constant (Δε) of the liquid crystal molecules 21 is set to 7 (positive type), and the initial alignment azimuth 22 of the liquid crystal molecules is set to be parallel to the longitudinal direction of sub-pixels and the longitudinal-shaped portion 16b of the opening 15b. Moreover, a pair of polarizing plates are arranged on the opposite side of a pair of substrates (the first substrate 10 and the second substrate 30) sandwiching the liquid crystal layer 20 to the liquid crystal layer 20. The pair of polarizing plates are arranged in the crossed Nicols so that the polarizing plate absorption axes are parallel and perpendicular to the initial alignment azimuth 22 of liquid crystal molecules, and are set to what is called a normally black mode which provides black display when the liquid crystal layer 20 is in the no-voltage-applied state.

The alignment distribution of the liquid crystal molecules 21 in the high-luminance display unit A-1 in the voltage-applied state (4 V application) will be described with reference to FIG. 11(b). In the high-luminance display unit A-1, when a voltage is applied between the pixel electrode 12b and the counter electrode 14b, the liquid crystal molecules 21 rapidly rotate to change the alignment state, and in the light-transmitting region 70b, two liquid crystal domains 23b are formed, and bend alignment is formed.

### (High-Speed Display Unit B-1)

FIG. 12 is a view relating to a high-speed display unit B-1, in which (a) is a plan view showing the opening shape of a counter electrode, and (b) is a plan view showing the simulation result of the alignment distribution of liquid crystal molecules in the voltage-applied state.

The high-speed display unit B-1 is set under the same conditions as those for the high-luminance display unit A-1 except that the shape of the opening 15a of the counter electrode 14a is changed to the shape of the solid line in FIG. 12(a).

The alignment distribution of the liquid crystal molecules 21 in the high-speed display unit B-1 in the voltage-applied state (4 V application) will be described with reference to FIG. 12(b). In the high-speed display unit B-1, when a voltage is applied between the pixel electrode 12a and the counter electrode 14a, the liquid crystal molecules 21 rapidly rotate to change the alignment state, and in the light-transmitting region 70a, four liquid crystal domains 23a are formed, and bend or splay alignment is formed.

### (High-Speed Display Unit B-2)

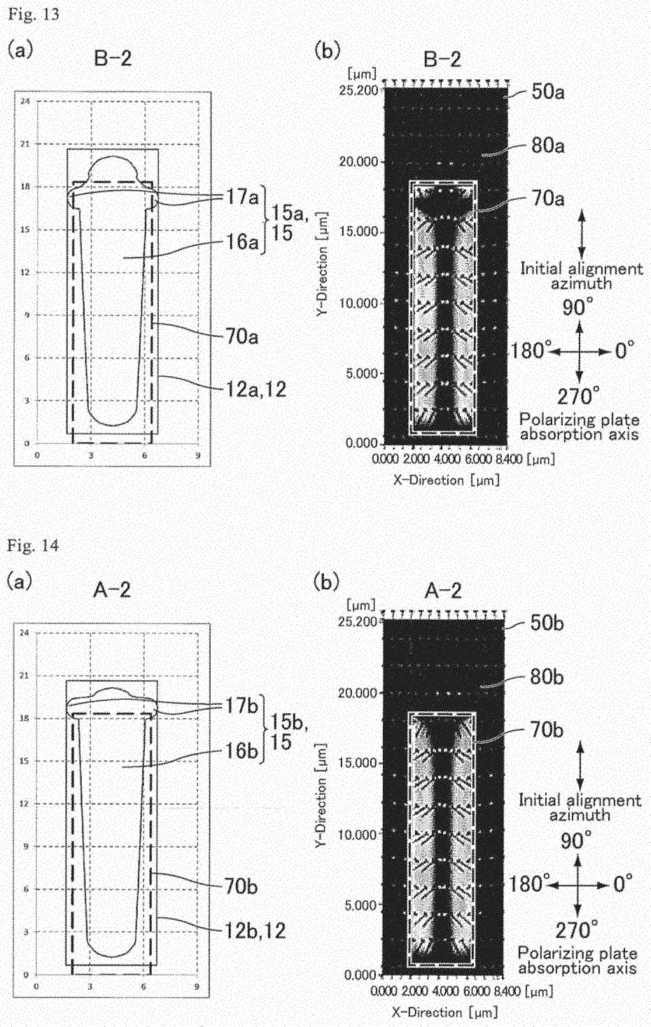

FIG. 13 is a view relating to a high-speed display unit B-2, in which (a) is a plan view showing the opening shape of a counter electrode, and (b) is a plan view showing the simulation result of the alignment distribution of liquid crystal molecules in the voltage-applied state.

The high-speed display unit B-2 is set under the same conditions as those for the high-luminance display unit A-1 except that the shape of the opening 15a of the counter electrode 14a is changed to the shape of the solid line in FIG. 13(a).

The alignment distribution of the liquid crystal molecules 21 in the high-speed display unit B-2 in the voltage-applied state (4 V application) will be described with reference to FIG. 13(b). In the high-speed display unit B-2, when a voltage is applied between the pixel electrode 12a and the counter electrode 14a, the liquid crystal molecules 21 rapidly rotate to change the alignment state, and in the light-transmitting region 70a, four liquid crystal domains including the two large liquid crystal domains 23a and the two small liquid crystal domains 23a are formed, and bend and splay alignment is formed.

### (High-Luminance Display Unit A-2)

FIG. 14 is a view relating to a high-luminance display unit A-2, in which (a) is a plan view showing the opening shape of a counter electrode, and (b) is a plan view showing the simulation result of the alignment distribution of liquid crystal molecules in the voltage-applied state.

The high-luminance display unit A-2 is set under the same conditions as those for the high-luminance display unit A-1 except that the shape of the opening 15b of the counter electrode 14b is changed to the shape of the solid line in FIG. 14(a).

The alignment distribution of the liquid crystal molecules 21 in the high-luminance display unit A-2 in the voltage-applied state (4 V application) will be described with reference to FIG. 14(b). In the high-luminance display unit A-2, when a voltage is applied between the pixel electrode 12b and the counter electrode 14b, the liquid crystal molecules 21 rapidly rotate to change the alignment state, and in the light-transmitting region 70b, two liquid crystal domains 23b are formed, and bend alignment is formed.

### (High-Luminance Display Unit A-3)

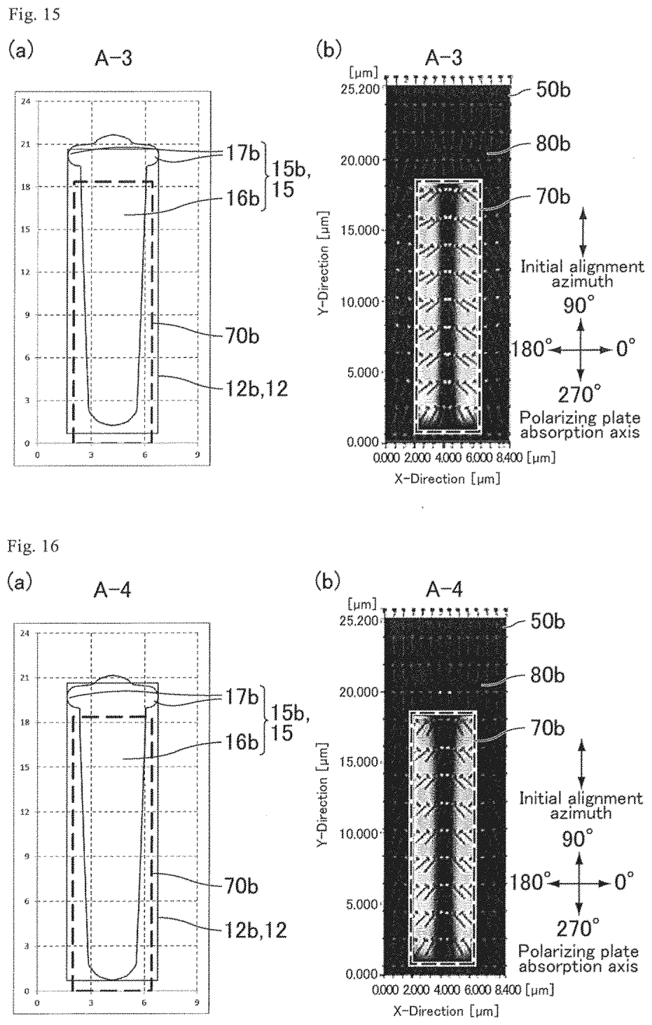

FIG. 15 is a view relating to a high-luminance display unit A-3, in which (a) is a plan view showing the opening shape of a counter electrode, and (b) is a plan view showing the simulation result of the alignment distribution of liquid crystal molecules in the voltage-applied state.

The high-luminance display unit A-3 is set under the same conditions as those for the high-luminance display unit A-1 except that the shape of the opening 15b of the counter electrode 14b is changed to the shape of the solid line in FIG. 15(a).

The alignment distribution of the liquid crystal molecules 21 in the high-luminance display unit A-3 in the voltage-applied state (4 V application) will be described with reference to FIG. 15(b). In the high-luminance display unit A-3, when a voltage is applied between the pixel electrode 12b and the counter electrode 14b, the liquid crystal molecules 21 rapidly rotate to change the alignment state, and in the light-transmitting region 70b, two liquid crystal domains 23b are formed, and bend alignment is formed.

### (High-Luminance Display Unit A-4)

FIG. 16 is a view relating to a high-luminance display unit A-4, in which (a) is a plan view showing the opening shape of a counter electrode, and (b) is a plan view showing the simulation result of the alignment distribution of liquid crystal molecules in the voltage-applied state.

The high-luminance display unit A-4 is set under the same conditions as those for the high-luminance display unit A-1 except that the shape of the opening 15b of the counter electrode 14b is changed to the shape of the solid line in FIG. 16(a).

The alignment distribution of the liquid crystal molecules 21 in the high-luminance display unit A-4 in the voltage-applied state (4 V application) will be described with reference to FIG. 16(b). In the high-luminance display unit A-4, when a voltage is applied between the pixel electrode 12b and the counter electrode 14b, the liquid crystal molecules 21 rapidly rotate to change the alignment state, and in the light-transmitting region 70b, two liquid crystal domains 23b are formed, and bend alignment is formed.

### (High-Luminance Display Unit A-5)

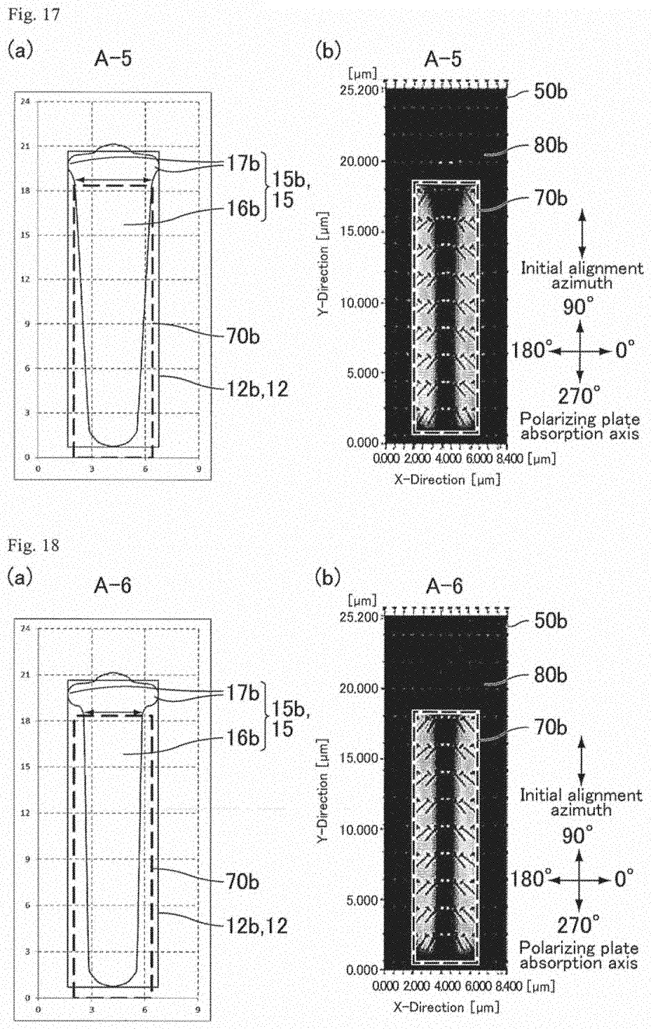

FIG. 17 is a view relating to a high-luminance display unit A-5, in which (a) is a plan view showing the opening shape of a counter electrode, and (b) is a plan view showing the simulation result of the alignment distribution of liquid crystal molecules in the voltage-applied state.

The high-luminance display unit A-5 is set under the same conditions as those for the high-luminance display unit A-1 except that the shape of the opening 15b of the counter electrode 14b is changed to the shape of the solid line in FIG. 17(a).

The alignment distribution of the liquid crystal molecules 21 in the high-luminance display unit A-5 in the voltage-applied state (4 V application) will be described with reference to FIG. 17(b). In the high-luminance display unit A-5, when a voltage is applied between the pixel electrode 12b and the counter electrode 14b, the liquid crystal molecules 21 rapidly rotate to change the alignment state, and in the light-transmitting region 70b, two liquid crystal domains 23b are formed, and bend alignment is formed.

### (High-Luminance Display Unit A-6)

FIG. 18 is a view relating to a high-luminance display unit A-6, in which (a) is a plan view showing the opening shape of a counter electrode, and (b) is a plan view showing the simulation result of the alignment distribution of liquid crystal molecules in the voltage-applied state.

The high-luminance display unit A-6 is set under the same conditions as those for the high-luminance display unit A-1 except that the shape of the opening 15b of the counter electrode 14b is changed to the shape of the solid line in FIG. 18(a).

The alignment distribution of the liquid crystal molecules 21 in the high-luminance display unit A-6 in the voltage-applied state (4 V application) will be described with reference to FIG. 18(b). In the high-luminance display unit A-6, when a voltage is applied between the pixel electrode 12b and the counter electrode 14b, the liquid crystal molecules 21 rapidly rotate to change the alignment state, and in the light-transmitting region 70b, two liquid crystal domains 23b are formed, and bend alignment is formed.

### (High-Luminance Display Unit A-7)

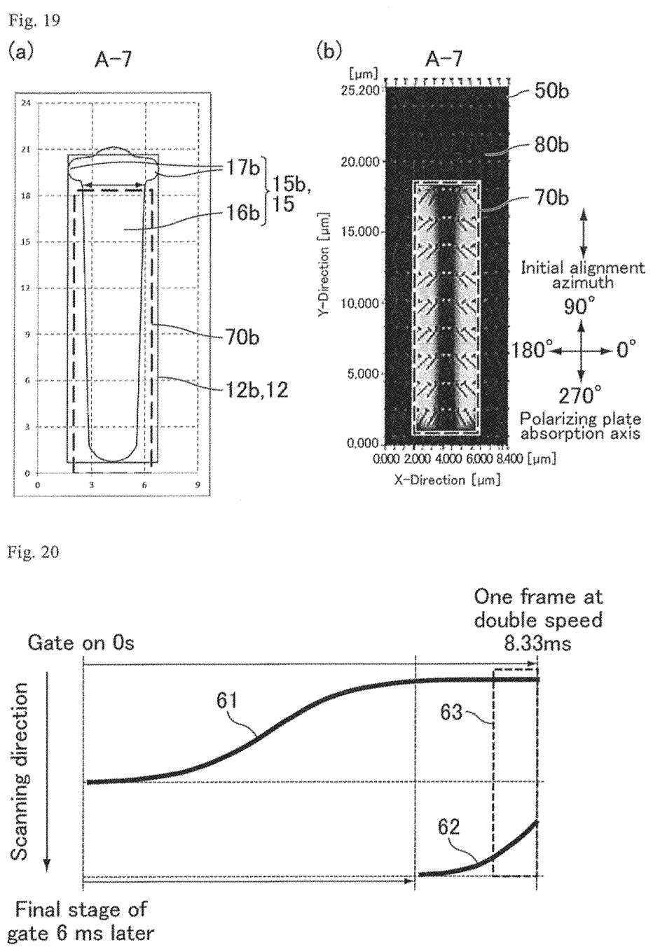

FIG. 19 is a view relating to a high-luminance display unit A-7, in which (a) is a plan view showing the opening shape of a counter electrode, and (b) is a plan view showing the simulation result of the alignment distribution of liquid crystal molecules in the voltage-applied state.

The high-luminance display unit A-7 is set under the same conditions as those for the high-luminance display unit A-1 except that the shape of the opening 15b of the counter electrode 14b is changed to the shape of the solid line in FIG. 19(a).

The alignment distribution of the liquid crystal molecules 21 in the high-luminance display unit A-7 in the voltage-applied state (4 V application) will be described with reference to FIG. 19(b). In the high-luminance display unit A-7, when a voltage is applied between the pixel electrode 12b and the counter electrode 14b, the liquid crystal molecules 21 rapidly rotate to change the alignment state, and in the light-transmitting region 70b, two liquid crystal domains 23b are formed, and bend alignment is formed.

### (Display Unit R-1 in FFS Mode Liquid Crystal Display Device According to Comparative Embodiment 1-1)

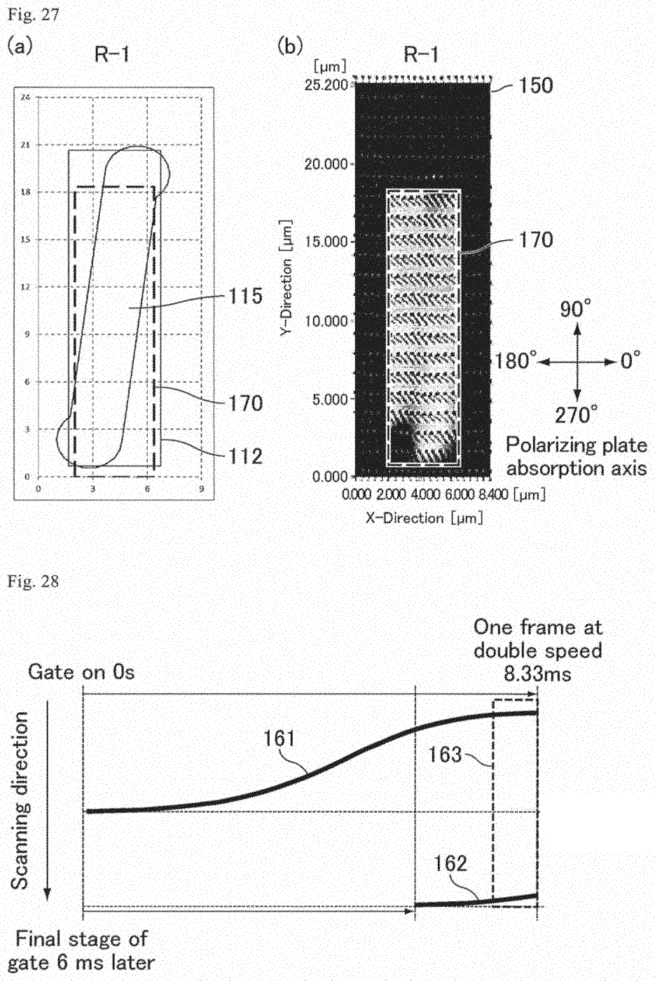

FIG. 27 is a view relating to a display unit R-1 in an FFS mode liquid crystal display device according to Comparative Embodiment 1-1, in which (a) is a plan view showing the opening shape of a counter electrode, and (b) is a plan view showing the simulation result of the alignment distribution of liquid crystal molecules in the voltage-applied state. The FFS mode liquid crystal display device according to Comparative Embodiment 1-1 is a conventional FFS mode liquid crystal display device.

A display unit R-1 is set under the same conditions as those for the high-luminance display unit A-1 except that the shape of the opening 115 of the counter electrode is changed to the shape of the solid line in FIG. 27(a).

The alignment distribution of liquid crystal molecules in the display unit R-1 in the voltage-applied state (4 V application) will be described with reference to FIG. 27(b). In the display unit R-1, when a voltage is applied between the pixel electrode 112 and the counter electrode, liquid crystal molecules rapidly rotate to change the alignment state, and in the light-transmitting region 170, one liquid crystal domain is formed.

### (Display Unit R-2 in High-Speed FFS Mode Liquid Crystal Display Device According to Comparative Embodiment 1-2)

A display unit R-2 in the high-speed FFS mode liquid crystal display device according to Comparative Embodiment 1-2 is set in the same manner as the display unit R-1 in the FFS mode liquid crystal display device according to Comparative Embodiment 1-1 except that the cell thickness is reduced to 264 nm to set a display unit with a small cell thickness. In the display unit R-2, when a voltage is applied between the pixel electrode 112 and the counter electrode, liquid crystal molecules rapidly rotate to change the alignment state, and in the light-transmitting region 170, one liquid crystal domain is formed.

### (Comparisons Between Display Units)

### <Evaluation of Black-White Response>

With the maximum transmittance obtainable by optical modulation being defined as a transmittance ratio of 100%, the rise response time is defined as time required for the transmittance ratio to change from 10% to 90%, and the decay response time is defined as time required for the transmittance ratio to change from 90% to 10%. The rise response characteristics correspond to switching from black display to white display, and the decay response characteristics correspond to switching from white display to black display. For each display unit, the rise response time and the decay response time are calculated manually, and the sum of the rise response time and the decay response time is divided by 2 to obtain the average value of the black-white response times (ms).

When the black-white response time is 8.1 ms or less, it is possible to cope with double speed display in which the number of display frames per second is increased to 120 frames, and good display performance can be obtained. Response judgment is performed such that if the black-white response time is 8.1 ms or less, it is marked with ◯, and if the black-white response time exceeds 8.1 ms, it is marked with x.

In general, “transmittance” indicates luminance when the liquid crystal panel lights up with respect to the luminance of the backlight. However, in this specification, “transmittance” indicates the transmittance obtained by dividing the transmittance of light transmitted through an opening portion (a portion excluding a light blocking portion, such as a black matrix) by the transmittance of a parallel Nicole polarizing plate. In principle, the parallel Nicole polarizing plate exhibits the maximum transmittance in the white state.

### <Evaluation of Transmittance and Transmittance Ratio>

A voltage of 4.0 V is applied to each display unit to obtain the transmittance in white display. Assuming that the transmittance of the display unit R-1 according to Comparative Embodiment 1-1 is a transmittance ratio of 100%, the transmittance ratio in each display unit is obtained. That is, the ratio (percentage) of the transmittance in each display unit to the transmittance in the display unit R-1 according to Comparative Embodiment 1-1 was assumed to be a transmittance ratio. Then, with reference to Comparative Embodiment 1-2, transmittance judgment is performed such that if the transmittance ratio is 70% or more, it is marked with ◯, and if the transmittance ratio is less than 70%, it is marked with x.

### <Comprehensive Judgment>

Assume that when good results are obtained in both transmittance ratio judgment and response judgment, comprehensive judgment is indicated by ◯; otherwise, comprehensive judgment is indicated by x.

Table 1 given below shows evaluation results in each display unit.

TABLE 1

| Display unit | | A-1 | B-1 | B-2 | A-2 | A-3 | A-4 |
|---|---|---|---|---|---|---|---|
| Pattern | | High | High speed | High speed | High | High | High |
| | | luminance | | | luminance | luminance | luminance |
| Transmittance | | 59% | 52% | 51% | 54% | 56% | 58% |
| Transmittance | Comparative | 80% | 71% | 70% | 73% | 76% | 78% |
| ratio | Embodiment | | | | | | |
| | 1-1 | | | | | | |

| | | | | | | |
|---|---|---|---|---|---|---|
| Transmittance judgment | Good | Good | Good | Good | Good | Good |
| Black-white response time (ms) | 6.3 | 5.0 | 5.3 | 5.7 | 5.8 | 6.5 |
| Response judgment | Good | Good | Good | Good | Good | Good |
| Comprehensive judgment | Good | Good | Good | Good | Good | Good |

| Display unit | | A-5 | A-6 | A-7 | R-1 | R-2 |
|---|---|---|---|---|---|---|
| Pattern | | High | High | High | FFS | FFS |
| | | luminance | luminance | luminance | | |
| Transmittance | | 56% | 58% | 58% | 73% | 51.3% |
| Transmittance | Comparative | 76% | 80% | 79% | 100% | 70% |
| ratio | Embodiment | | | | | |
| | 1-1 | | | | | |

| | | | | | |
|---|---|---|---|---|---|
| Transmittance judgment | Good | Good | Good | Good | Good |
| Black-white response time (ms) | 6.0 | 6.3 | 6.4 | 9.3 | 8.2 |
| Response judgment | Good | Good | Good | Poor | Poor |
| Comprehensive judgment | Good | Good | Good | Poor | Poor |

The black-white response times are short and the transmittances are also good in all the high-luminance display units A-1 to A-7 and the high-speed display units B-1 to B-2 each having the opening 15a or 15b including the longitudinal-shaped portion 16a or 16b and the pair of protrusions 17a or 17b protruding to opposite sides from the longitudinal-shaped portion 16a or 16b.

In the high-luminance display unit A-1, part of the dark lines is hidden in the light-blocking region 80b, so that a high transmittance ratio (80%) is obtained. In addition, the response speed of the liquid crystal molecules 21 is increased by the bend liquid crystal alignment, and the black-white response time is 6.3 ms.

The opening 15a in the high-speed display unit B-1 has an opening shape provided with the pair of protrusions 17a at the center of the longitudinal-shaped portion 16a, and the liquid crystal domains 23a are formed in the four substantially symmetrical regions. This increases the black-white response by 1.3 ms compared with the high-luminance display unit A-1. However, since the cross-shaped dark lines exist in the light-transmitting region 70a, the transmittance ratio is reduced by 9% compared with the high-luminance display unit A-1.

In the opening 15a in the high-speed display unit B-2, the pair of protrusions 17a are located in the region obtained by expanding the light-transmitting region 70a in the transverse direction of the longitudinal-shaped portion 16a. In the high-speed display unit B-2, the cross-shaped dark lines are not hidden in the light-blocking region 80a and the transmittance ratio is 70%. However, since the four liquid crystal domains 23a form a bend alignment, the black-white response time is increased to 5.3 ms. However, the black-white response time of the high-speed display unit B-2 is 0.3 ms later than the black-white response time of the high-speed display unit B-1. In the opening 15a of the high-speed display unit B-2, the distance from the pair of protrusions 17a to the longitudinal-shaped portion 16a extending downward increases, and the shape of the bend arc for improving the response speed becomes long. As a result, the force of distortion of the bend decreases, and the effect of improving the response speed decreases.

In the opening 15b in the high-luminance display unit A-2, the pair of protrusions 17b are located outside the region obtained by expanding the light-transmitting region 70b in the transverse direction of the longitudinal-shaped portion 16b. In the high-luminance display unit A-2, the response speed is slowed for the same reason as in the high-speed display unit B-2, but part of the dark lines is hidden in the light-blocking region 80b, so the transmittance ratio is improved to 73%.

The high-luminance display unit A-3 has the opening 15b with a shape in which the pair of protrusions 17b in the opening 15b of the high-luminance display unit A-2 are pushed in until they protrude slightly from the pixel electrode 12b. The response speed of the high-luminance display unit A-3 is almost the same as that of the high-luminance display unit A-2. In addition, because the dark lines are completely hidden in the light-blocking region 80b, the transmittance ratio is 76%, and a high luminance improving effect is obtained.

The high-luminance display unit A-4 has the opening 15b with the shape obtained by slightly extending the cut-out shape of the longitudinal-shaped portion 16b on the opposite side to the protrusions 17b in the opening 15b of the high-luminance display unit A-3 in the longitudinal direction of the longitudinal-shaped portion 16b. The transmittance ratio can be further improved by slightly widening the longitudinal-shaped portion 16b from the pixel electrode 12b with respect to the high-luminance display unit A-3. However, because the distance from the dark lines extending in the lateral direction has increased, the response speed further decreases.

The high-luminance display unit A-5 has an opening 15b with the shape obtained by widening the root of the long side of the pair of protrusions 16b in the opening 15b of the high-luminance display unit A-4 by 0.3 μm. The transmittance ratio of the high-luminance display unit A-5 is 76%, which is almost the same as that of the high-luminance display unit A-4, and the effect obtained by widening the longitudinal-shaped portion 16b upward and downward deteriorates. This is because the width of the electrode in the lateral direction is large, the dark lines at the center are difficult to distort, and the line width of the dark lines does not decrease. In addition, the response speed slightly decreases.

The high-luminance display units A-6 and A-7 respectively have openings 15b with the shapes obtained by narrowing the root of the long side of the pair of protrusions 17b in the opening 15b of the high-luminance display unit A-1 by 0.2 μm and 0.1 μm. When the width of the opening 15b in the lateral direction is smaller than that of the high-luminance display unit A-1, the distortion of the liquid crystal molecules 21 increases, and the response speed is improved.

### Embodiment 1

In an FFS mode liquid crystal display device according to Embodiment 1, display units 4 connected to a gate signal line Y of the first stage to a gate signal line Y of the 1499th stage among the 2000 gate signal lines Y are set as high-luminance display units A-1, and display units 4 connected to the gate signal line Y of the 1500th stage to the gate signal line Y of 2000th stage are set as high-speed display units B-1.

### Comparative Embodiment 1-2

Display units R-2 are arranged over the entire display region to obtain an FFS mode liquid crystal display device according to Comparative Embodiment 1-2 with a small cell gap.

As a backlight for each of the FFS mode liquid crystal display devices according to Embodiment 1 and Comparative Embodiment 1-2, a backlight with a duty ratio of 10% configured to light up in a last period of 1/10 of one frame is used. The gate driver is configured to perform high-speed writing and finish writing in 6 ms.

FIG. 20 is a schematic view showing a relationship between the response of liquid crystal molecules and the backlight in the liquid crystal display device according to Embodiment 1. FIG. 28 is a schematic view showing a luminance curve in a display unit of the liquid crystal display device according to Comparative Embodiment 1-2.

As indicated by a luminance curve 161 in FIG. 28, in the liquid crystal display device according to Comparative Embodiment 1-2, in the display region corresponding to the initial stage to the middle stage of a gate scan, liquid crystal molecules sufficiently respond by a period 163 during which the backlight lights up, and hence sufficient luminance can be obtained. However, in a display unit located at the final stage of the gate scan, writing of a data signal is delayed, and as indicated by a luminance curve 162 in FIG. 28, liquid crystal molecules cannot respond sufficiently until the backlight lights up. Therefore, the response of the liquid crystal molecules delays at the final stage of the gate scan, and image blurring occurs when a moving image is displayed.

In the liquid crystal display device 1 according to Embodiment 1, the display units 4 connected to the gate signal line Y of the first stage to the gate signal line Y of the 1499th stage are set as the high-luminance display units A-1 with a black-white response time of 6.3 ms, and the display units 4 connected to the gate signal line Y of the 1500th stage to the gate signal line Y of the 2000th stage are set as the high-speed display units B-1 with a black-white response time of 5.0 ms. The black-white response time in the region corresponding to the gate signal line Y of the 1500th stage to the gate signal line Y of the 2000th stage is shorter by 1.3 ms than in the remaining region.

As shown in FIG. 20, a driving voltage for the liquid crystal molecules 21 is applied to the display unit 4 connected to the gate signal line of the first stage at 0 s after the start of one frame (at the same time as the start of one frame), and a luminance curve 61 (also referred to as a response curve) rises. In the display unit 4 connected to the gate signal line of the final stage (2000th stage), the driving voltage for the liquid crystal molecules 21 is applied at 6 ms after the start of one frame, and a luminance curve 62 rises. The display unit 4 connected to the gate signal line of the first stage is the high-luminance display unit A-1, and the display unit 4 connected to the gate signal line of the final stage (2000th stage) is the high-speed display unit B-1, so that the luminance curve 62 of the display unit 4 connected to the gate signal line of the final stage (2000th stage) rises sharply. Note that the liquid crystal display device according to Embodiment 1 is driven at double speed (120 Hz; 1 frame= 1/120 second=8.33 ms). Accordingly, because the time from the writing of a data signal in the region corresponding to the gate signal line of the 2000th stage as the final stage until the end of one frame period is 8.33 ms−6 ms=2.33 ms, high-speed display units may preferably be arranged from a position corresponding to about ¾ of a gate scan period in which a response curve rises up to about ⅔.

As indicated by the luminance curve 61 in FIG. 20, in the liquid crystal display device 1 according to Embodiment 1, in a display region 3 corresponding to the gate signal line Y of the first stage to the gate signal line Y of the 1499th stage, liquid crystal molecules 21 sufficiently respond by a period 63 during which the backlight 60 lights up, and hence sufficient luminance can be obtained. Further, as indicated by the luminance curve 62 in FIG. 20 as an example, in a display region 3 corresponding to the gate signal line Y of the 1500th gate to the gate signal line Y of the 2000th gate as well, the liquid crystal molecules 21 respond to some extent when the backlight 60 lights up, and the luminance curve can be improved by 50% or more. Therefore, in the liquid crystal display device 1 according to Embodiment 1, it is possible to suppress image blurring when moving images are displayed.

### Embodiments 2-1 to 2-24

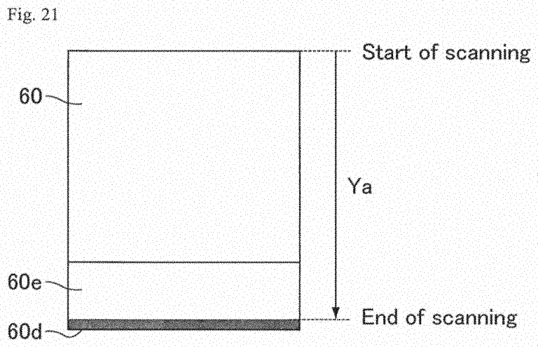

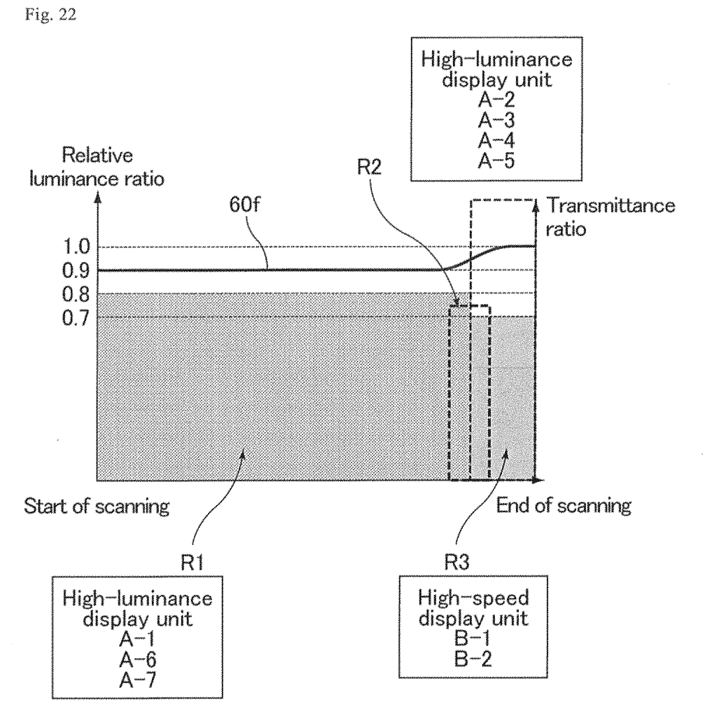

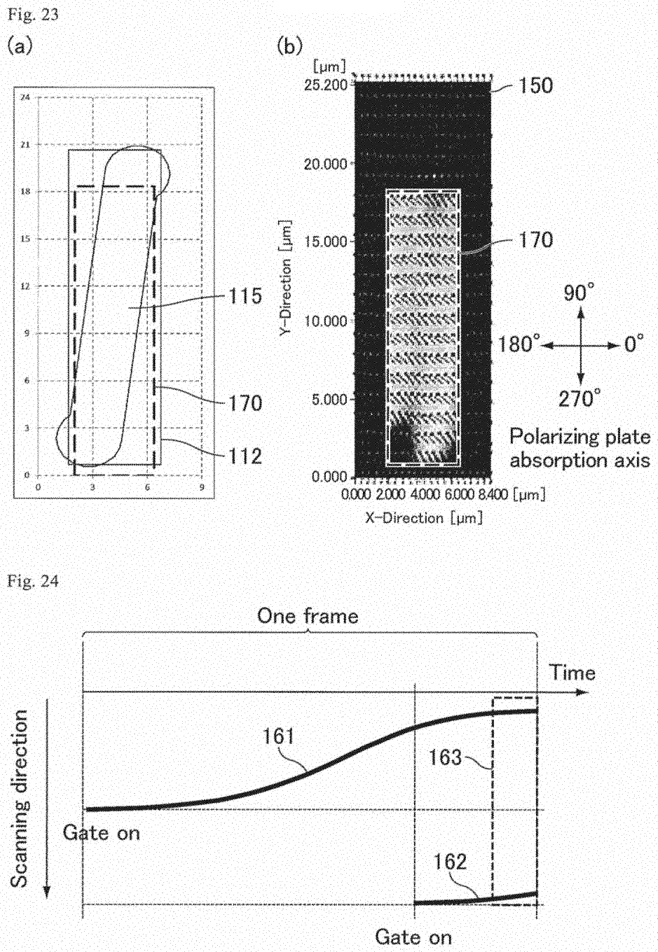

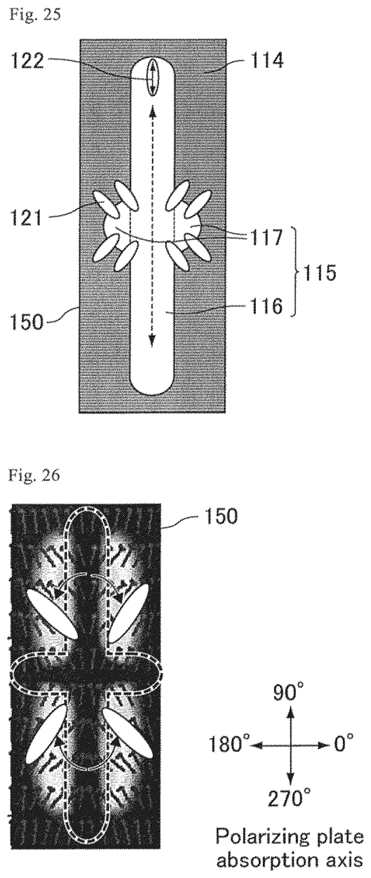

Liquid crystal display devices 1 according to Embodiments 2-1 to 2-24 include high-luminance display units A-1 to A-7, high-speed display units B-1 to B-2, and backlights 60 having characteristics in the luminance distribution. FIG. 21 is a schematic plan view showing the luminance distribution of the backlight used for each of the liquid crystal display devices according to Embodiments 2-1 to 2-24. FIG. 22 is a schematic plan view showing the relationship between the arrangement of display units and the luminance distribution of the backlight in each of the liquid crystal display devices according to Embodiments 2-1 to 2-24.

In each of the liquid crystal display devices 1 according to Embodiments 2-1 to 2-24, in order to further increase the luminance of a high-speed display unit 50a disposed at the final stage of a gate scan on the light-emitting surface of the backlight 60, a region 60e in which the luminance distribution of the backlight 60 is 10% higher than the remaining region is provided near a light incident surface 60d on which light from a light source 60a is incident, and the high-speed display unit 50a is disposed in the region 60e. That is, each of the liquid crystal display devices 1 according to Embodiments 2-1 to 2-24 uses the backlight 60 with a luminance curve 60f shown in FIG. 22 which indicates that the luminance of the backlight 60 near the light incident surface 60d of the LED is 100%, and the luminance of the backlight 60 in the remaining region is 90%.

In each of the liquid crystal display devices 1 according to Embodiments 2-1 to 2-24, the region R2 where the high-luminance display unit 50b with a transmittance ratio of about 70% to 80% is disposed is provided between a region R1 where a high-luminance display unit 50b with a transmittance ratio of about 80% is disposed and a region R3 where the high-speed display unit 50a with a transmittance ratio of about 70% is disposed. Using the backlight 60 with a luminance curve 60f indicating that the differences in transmittance ratio among these three regions are canceled each other can make the luminance uniform over the entire surface of the liquid crystal panel 2. Table 2 below shows the configurations of the liquid crystal display devices 1 according to Embodiments 2-1 to 2-24.

TABLE 2

| | Region | | Region | | Region | |
|---|---|---|---|---|---|---|
| | R1 | | R2 | | R3 | |
| [Embodiment 2-1] | High-luminance | A-1 | High-luminance | A-2 | High-speed | B-1 |
| | display unit | | display unit | | display unit | |
| [Embodiment 2-2] | High-luminance | A-1 | High-luminance | A-2 | High-speed | B-2 |
| | display unit | | display unit | | display unit | |
| [Embodiment 2-3] | High-luminance | A-1 | High-luminance | A-3 | High-speed | B-1 |
| | display unit | | display unit | | display unit | |
| [Embodiment 2-4] | High-luminance | A-1 | High-luminance | A-3 | High-speed | B-2 |
| | display unit | | display unit | | display unit | |
| [Embodiment 2-5] | High-luminance | A-1 | High-luminance | A-4 | High-speed | B-1 |
| | display unit | | display unit | | display unit | |
| [Embodiment 2-6] | High-luminance | A-1 | High-luminance | A-4 | High-speed | B-2 |
| | display unit | | display unit | | display unit | |
| [Embodiment 2-7] | High-luminance | A-1 | High-luminance | A-5 | High-speed | B-1 |
| | display unit | | display unit | | display unit | |
| [Embodiment 2-8] | High-luminance | A-1 | High-luminance | A-5 | High-speed | B-2 |
| | display unit | | display unit | | display unit | |
| [Embodiment 2-9] | High-luminance | A-6 | High-luminance | A-2 | High-speed | B-1 |
| | display unit | | display unit | | display unit | |
| [Embodiment 2-10] | High-luminance | A-6 | High-luminance | A-2 | High-speed | B-2 |
| | display unit | | display unit | | display unit | |
| [Embodiment 2-11] | High-luminance | A-6 | High-luminance | A-3 | High-speed | B-1 |
| | display unit | | display unit | | display unit | |
| [Embodiment 2-12] | High-luminance | A-6 | High-luminance | A-3 | High-speed | B-2 |
| | display unit | | display unit | | display unit | |
| [Embodiment 2-13] | High-luminance | A-6 | High-luminance | A-4 | High-speed | B-1 |
| | display unit | | display unit | | display unit | |
| [Embodiment 2-14] | High-luminance | A-6 | High-luminance | A-4 | High-speed | B-2 |
| | display unit | | display unit | | display unit | |
| [Embodiment 2-15] | High-luminance | A-6 | High-luminance | A-5 | High-speed | B-1 |
| | display unit | | display unit | | display unit | |
| [Embodiment 2-16] | High-luminance | A-6 | High-luminance | A-5 | High-speed | B-2 |
| | display unit | | display unit | | display unit | |
| [Embodiment 2-17] | High-luminance | A-7 | High-luminance | A-2 | High-speed | B-1 |
| | display unit | | display unit | | display unit | |
| [Embodiment 2-18] | High-luminance | A-7 | High-luminance | A-2 | High-speed | B-2 |
| | display unit | | display unit | | display unit | |
| [Embodiment 2-19] | High-luminance | A-7 | High-luminance | A-3 | High-speed | B-1 |
| | display unit | | display unit | | display unit | |
| [Embodiment 2-20] | High-luminance | A-7 | High-luminance | A-3 | High-speed | B-2 |
| | display unit | | display unit | | display unit | |
| [Embodiment 2-21] | High-luminance | A-7 | High-luminance | A-4 | High-speed | B-1 |
| | display unit | | display unit | | display unit | |
| [Embodiment 2-22] | High-luminance | A-7 | High-luminance | A-4 | High-speed | B-2 |
| | display unit | | display unit | | display unit | |
| [Embodiment 2-23] | High-luminance | A-7 | High-luminance | A-5 | High-speed | B-1 |
| | display unit | | display unit | | display unit | |
| [Embodiment 2-24] | High-luminance | A-7 | High-luminance | A-5 | High-speed | B-2 |
| | display unit | | display unit | | display unit | |

In each of the liquid crystal display devices 1 according to Embodiments 2-1 to 2-24, a reduction in luminance in the high-speed display unit 50a can be compensated for by setting the display region 3 where the high-speed display unit 50a is disposed as a region 60e where the luminance distribution of the backlight 60 is high, that is, by making the luminance of the backlight 60 in a region corresponding to the high-speed display unit 50a higher than that of the backlight 60 in a region corresponding to the high-luminance display unit 50b. By providing the backlight 60 with a luminance distribution and disposing the high-speed display unit 50a and the high-luminance display unit 50b in accordance with the luminance distribution of the backlight 60, it is possible to obtain the uniform high-definition liquid crystal display device 1 that provides bright images without motion sickness.

Each and every detail described for Embodiments of the present invention shall be applied to all the aspects of the present invention.

### ADDITIONAL REMARKS

One aspect of the present invention may be a liquid crystal display device including the first substrate 10, the second substrate 30 facing the first substrate 10, the liquid crystal layer 20 provided between the first substrate 10 and the second substrate 30 and containing the liquid crystal molecules 21, and the display region 3 including the display units 4 arranged in a matrix, wherein the first substrate 10 includes the first electrode 12, 12a, or 12b, the second electrode 14, 14a, or 14b provided closer to the liquid crystal layer 20 than the first electrode 12, 12a, or 12b, and the insulating film 13 provided between the first electrode 12, 12a, or 12b and the second electrode 14, 14a, or 14b, the liquid crystal molecules 21 are aligned parallel to the first substrate 10 in a no-voltage-applied state in which no voltage is applied between the first electrode 12, 12a, or 12b and the second electrode 14, 14a, or 14b, the second electrode 14, 14a, or 14b in each of the display units 4 is provided with the opening 15, 15a, or 15b including the longitudinal-shaped portion 16a or 16b and the pair of protrusions 17a or 17b protruding to opposite sides from the longitudinal-shaped portion 16a or 16b, the pair of protrusions 17a or 17b are provided on portions excluding both the end portions of the longitudinal-shaped portion 16a or 16b in the longitudinal direction and located in places corresponding to each other, each of the display units 4 includes the light-transmitting region 70a or 70b which can transmit light and the light-blocking region 80a or 80b which blocks light in a plan view, the light-transmitting region 70a or 70b is formed so as to overlap the longitudinal-shaped portion 16a or 16b in each of the display units 4, each of the display units 4 including the high-speed display unit 50a in which the four liquid crystal domains 23a are generated in the light-transmitting region 70a in a voltage-applied state in which a voltage is applied between the first electrode 12, 12a, or 12b and the second electrode 14, 14a, or 14b and the high-luminance display unit 50b in which the two liquid crystal domains 23b are generated in the light-transmitting region 70b in the voltage-applied state, and a data signal is written in the high-speed display unit 50a later than in the high-luminance display unit 50b within one frame period.

As described above, because in each of the display units 4, the second electrode 14, 14a, or 14b is provided with the opening 15, 15a, or 15b including the longitudinal-shaped portion 16a or 16b and the pair of protrusions 17a or 17b protruding to opposite sides from the longitudinal-shaped portion 16a or 16b, and the pair of protrusions 17a or 17b are provided on portions excluding both the end portions of the longitudinal-shaped portion 16a or 16b in the longitudinal direction and located in places corresponding to each other, the four liquid crystal domains 23a or 23b can be formed per one opening 15, 15a, or 15b in the voltage-applied state. This can rotate the liquid crystal molecules 21 in the adjacent liquid crystal domains 23a or 23b in opposite azimuths. As a result, in each display unit 4, distortion (twisting force) can be generated in the liquid crystal alignment, and the response speed can be increased compared with a general FFS mode. It is unnecessary to form the opening 15, 15a, and 15b having complicated shapes in the second electrodes 14, 14a, and 14b, and high definition can be achieved.

Each of the display units 4 includes the high-speed display unit 50a in which the four liquid crystal domains 23a are generated in the light-transmitting region 70a in the voltage-applied state in which a voltage is applied between the first electrode 12, 12a, or 12b and the second electrode 14, 14a, or 14b and the high-luminance display unit 50b in which the two liquid crystal domains 23b are generated in the light-transmitting region 70b in the voltage-applied state. This reduces the distortion of the liquid crystal alignment occurring in the voltage-applied state in the high-luminance display unit 50b as compared with the high-speed display unit 50a, and hence the response speed is relatively slow. However, in the light-transmitting region 70b, because the region occupied by dark lines between the adjacent liquid crystal domains 23b can be reduced as compared with the high-speed display unit 50a, the transmittance can be relatively increased. On the other hand, in the high-speed display unit 50a, because the region occupied by the dark lines between the adjacent liquid crystal domains 23a in the light-transmitting region 70a is larger than that in the high-luminance display unit 50b, the transmittance becomes relatively small, whereas the response speed can be relatively increased because the distortion of liquid crystal alignment occurring in the voltage-applied state can be made larger than that in the high-luminance display unit 50b.

A data signal is then written in the high-speed display unit 50a later than in the high-luminance display unit 50b within one frame period, that is, a data signal is written in the high-luminance display unit 50b earlier than in the high-speed display unit 50a within one frame period. Accordingly, the time for liquid crystal response for the high-luminance display unit 50b having a relatively low response speed can be ensured, and hence the occurrence of image blurring can be reduced in the region provided with the high-luminance display unit 50b, whereas although the time for liquid crystal response with respect to the high-speed display unit 50a is shortened, because the response speed is relatively high, the occurrence of image blurring can be reduced even in a region provided with the high-speed display unit 50a.

As described above, the occurrence of image blurring can be reduced in the region provided with the high-luminance display unit 50b and the region provided with the high-speed display unit 50a while a reduction in luminance in the region provided with the high-luminance display unit 50b, that is, part of the display region 3, is reduced. In addition, it is possible to achieve high definition of each display unit 4.

The pair of protrusions 17a of the high-speed display unit 50a may be located in a region 72a combining the light-transmitting region 70a and the region 71a obtained by virtually expanding the light-transmitting region 70a in the transverse direction of the longitudinal-shaped portion 16a in a plan view. Using such an aspect can easily form the four liquid crystal domains 23a in the light-transmitting region 70a.

The pair of protrusions 17a of the high-speed display unit 50a may protrude from the intermediate portion of the longitudinal-shaped portion 16a. When such an aspect is adopted, it is possible to further increase the response speed of the high-speed display unit 50a.

The pair of protrusions 17b of the high-luminance display unit 50b may be located outside the region 72b combining the light-transmitting region 70b and the region 71b obtained by virtually expanding the light-transmitting region 70b in the transverse direction of the longitudinal-shaped portion 16b in a plan view. Using such an aspect can easily form the two liquid crystal domains 23b in the light-transmitting region 70b.

The pair of protrusions 17b of the high-luminance display unit 50b may be adjacent to one of the end portions of the longitudinal-shaped portion 16b. When such an aspect is adopted, it is possible to further increase the transmittance of the high-luminance display unit 50b.

The high-speed display unit 50a may be located at an end of the display region 3. Such an aspect is suitably used when a gate scan is performed in one direction.

The liquid crystal molecules 21 may have positive anisotropy of dielectric constant. Because the liquid crystal molecules 21 having positive anisotropy of dielectric constant have a relatively lower viscosity than the liquid crystal molecules 21 having negative anisotropy of dielectric constant, the response speed can be further improved.

The longitudinal direction of the longitudinal-shaped portion 16a or 16b may be parallel to the alignment azimuth of the liquid crystal molecules 21 in a plan view in the no-voltage-applied state described above. When such an aspect is adopted, the symmetry of the liquid crystal domains 23a or 23b in the voltage-applied state increases, and the response speed can be further increased.

The liquid crystal display device 1 may further include the backlight 60, 60A, or 60B provided on the opposite side of the first substrate 10 or the second substrate 30 to the liquid crystal layer 20. The luminance of the backlight 60, 60A, or 60B in the region corresponding to the high-speed display unit 50a may be higher than that of the backlight 60, 60A, or 60B in the region corresponding to the high-luminance display unit 50b. By adopting such an aspect, the luminance of the high-speed display unit 50a having a lower transmittance than that of the high-luminance display unit 50b is increased, and the luminance can be made uniform over the entire surface of the display region 3.

The backlight 60, 60A, or 60B may include the light source 60a that lights up for a predetermined time in one frame period, and the light source 60a may start lighting at a later time than when the high-speed display unit 50a is driven. By adopting such an aspect, lighting can be performed in a state in which the response of the liquid crystal molecules 21 has further advanced, so that image blurring can be further suppressed.

The backlight 60A may include a light guide plate 60b facing the first substrate 10 or the second substrate 30 and the light source 60a configured to irradiate the light incident surface 60d of the light guide plate 60b with light, and the high-speed display unit 50a may be located closer to the light incident surface 60d of the light guide plate 60b than the high-luminance display unit 50b. By adopting such an aspect, it is possible to easily increase the luminance of the backlight 60A in a region corresponding to the high-speed display unit 50a with insufficient luminance, and it is easy to obtain a bright image on the entire surface of the liquid crystal panel 2.

The first substrate 10 may further include multiple gate signal lines Y which are provided for each row or column of the display unit 4 and which are scanned line-sequentially in a predetermined direction, and the high-speed display unit 50a may be connected to a gate signal line Y of the final stage of the gate signal lines Y. With such an aspect, it is possible to easily write a data signal in the high-speed display unit 50a later than the high-luminance display unit 50b within one frame period.

The display units 4 may include the high-speed display units 50a, and each of the high-speed display units 50a may be connected to any of the gate signal lines Y of the consecutive stages including the gate signal line Y of the final stage among the gate signal lines Y. By adopting such an aspect, it is possible to increase the response speed of the display unit 4 in which a data signal is written in a certain period at the final stage of the gate scan, so that the image blurring can be further suppressed.

At least one of the end portions of the longitudinal-shaped portion 16a or 16b may be rounded. Adopting such an aspect can generate an electric field in an oblique direction at the rounded end portion and improve the response speed.

The high-speed display unit 50a may include cross-shaped dark lines at the center of the four liquid crystal domains 23a. When such an aspect is adopted, it is possible to further improve the response speed.

The embodiments of the present invention shown above may be combined as appropriate within the spirit of the present invention.

### REFERENCE SIGNS LIST

1 Liquid crystal display device
2 Liquid crystal panel
3 Display region
4, 150 Display unit
5 Gate driver
6 Source driver
7 controller
8 Drive circuit region
10 First substrate
11, 31 Insulating substrate (for example, glass substrate)
12, 12a, 12b, 112 Pixel electrode (first electrode)
13 Insulating layer (insulating film)
14, 14a, 14b, 114 Counter electrode (second electrode)
15, 15a, 15b, 115 Opening
16a, 16b, 116 Longitudinal-shaped portion
17a, 17b, 117 Protrusion
18a, 18b Electric field
20 Liquid crystal layer
21, 121 Liquid crystal molecules
22 Initial alignment azimuth of liquid crystal molecules
23a, 23b Liquid crystal domain
30 Second substrate
32 Color filter
33 Overcoat layer
40 Thin-film transistor (TFT)
50a High-speed display unit
50b High-luminance display unit
55a, 55b First line segment
56a, 56b Second line segment
57a Third line segment
58a Fourth line segment
60, 60A, 60B Backlight
60a Light source
60b Light guide plate
60c Diffusion plate
60d Light incident surface
60e Region with high luminance distribution of backlight
60f, 161, 162 Luminance curve
61 Luminance curve of high-luminance display unit
62 Luminance curve of high-speed display unit
63, 163 Period during which backlight lights up
70a, 70b, 170 Light-transmitting region
71a, 71b Region obtained by virtually expanding light-transmitting region in transverse direction of longitudinal-shaped portion
72a, 72b Region combining light-transmitting region and region obtained by virtually expanding light-transmitting region in transverse direction of longitudinal-shaped portion
80a, 80b Light-blocking region
122 Alignment azimuth of liquid crystal molecules in no-voltage-applied state
151a, 151b Upper end portion
152a, 152b Lower end portion
153a, 153b Left end portion
154a, 154b Right end portion
155a, 155b First inclined contour
156a, 156b Second inclined contour
157a, 157b Third inclined contour
158a, 158b Fourth inclined contour
211A, 212A Liquid crystal molecules in no-voltage-applied state
211B, 212B Liquid crystal molecules in voltage-applied state
A, B Region surrounded by dotted line
R1 Region in which high-luminance display unit with transmittance ratio of about 80% is disposed
R2 Region in which high-luminance display unit with transmittance ratio of about 70% to 80% is disposed
R3 Region in which high-speed display unit with transmittance ratio of about 70% is disposed
X, X1, X2, X3, Xm Source signal line
Y, Y1, Y2, Y3, Yn Gate signal line
Ya Gate scan direction

1. A liquid crystal display device comprising:
a first substrate;
a second substrate facing the first substrate;
a liquid crystal layer provided between the first substrate and the second substrate and containing liquid crystal molecules; and
a display region including multiple display units arranged in a matrix,
wherein the first substrate includes a first electrode, a second electrode provided closer to the liquid crystal layer than the first electrode, and an insulating film provided between the first electrode and the second electrode,
the liquid crystal molecules are aligned parallel to the first substrate in a no-voltage-applied state in which no voltage is applied between the first electrode and the second electrode,
the second electrode in each of the display units is provided with an opening including a longitudinal-shaped portion and a pair of protrusions protruding to opposite sides from the longitudinal-shaped portion,
the pair of protrusions are provided on portions excluding both end portions of the longitudinal-shaped portion in a longitudinal direction and located in places corresponding to each other,
each of the display units includes a light-transmitting region which is configured to transmit light and a light-blocking region which blocks light in a plan view,
the light-transmitting region is formed so as to overlap the longitudinal-shaped portion in each of the display units,
the display units include at least one high-speed display unit in which four liquid crystal domains are generated in the light-transmitting region in a voltage-applied state in which a voltage is applied between the first electrode and the second electrode and at least one high-luminance display unit in which two liquid crystal domains are generated in the light-transmitting region in the voltage-applied state, and
a data signal is written in the at least one high-speed display unit later than in the at least one high-luminance display unit within one frame period.

2. The liquid crystal display device according to claim 1,
wherein the pair of protrusions of the at least one high-speed display unit are located in a region combining the light-transmitting region and a region obtained by virtually expanding the light-transmitting region in a transverse direction of the longitudinal-shaped portion in a plan view.

3. The liquid crystal display device according to claim 1,
wherein the pair of protrusions of the at least one high-speed display unit protrude from an intermediate portion of the longitudinal-shaped portion.

4. The liquid crystal display device according to claim 1,
wherein the pair of protrusions of the at least one high-luminance display unit are located outside a region combining the light-transmitting region and a region obtained by virtually expanding the light-transmitting region in a transverse direction of the longitudinal-shaped portion in a plan view.

5. The liquid crystal display device according to claim 1,
wherein the pair of protrusions of the at least one high-luminance display unit are adjacent to one of the end portions of the longitudinal-shaped portion.

6. The liquid crystal display device according to claim 1,
wherein the at least one high-speed display unit is located at an end of the display region.

7. The liquid crystal display device according to claim 1,
wherein the liquid crystal molecules have positive anisotropy of dielectric constant.

8. The liquid crystal display device according to claim 1,
wherein the longitudinal direction of the longitudinal-shaped portion is parallel to the alignment azimuth of the liquid crystal molecules in a plan view in the no-voltage-applied state.

9. The liquid crystal display device according to claim 1, further comprising a backlight provided on an opposite side of the first substrate or the second substrate to the liquid crystal layer,
wherein a luminance of the backlight in a region corresponding to the at least one high-speed display unit is higher than a luminance of the backlight in a region corresponding to the at least one high-luminance display unit.

10. The liquid crystal display device according to claim 9,
wherein the backlight includes a light source that lights up for a predetermined time in one frame period, and
the light source starts lighting at a later time than when the at least one high-speed display unit is driven.

11. The liquid crystal display device according to claim 9,
wherein the backlight includes a light guide plate facing the first substrate or the second substrate and a light source configured to irradiate a light incident surface of the light guide plate with light, and
the at least one high-speed display unit is located closer to the light incident surface of the light guide plate than the at least one high-luminance display unit.

12. The liquid crystal display device according to claim 1,
wherein the first substrate further includes multiple gate signal lines which are provided for each row or column of the display units and which are scanned line-sequentially in a predetermined direction, and
the at least one high-speed display unit is connected to a gate signal line of a final stage of the gate signal lines.

13. The liquid crystal display device according to claim 12,
wherein the display units include a plurality of the high-speed display units, and
each of the high-speed display units is connected to any of the gate signal lines of consecutive stages including the gate signal line of the final stage.

14. The liquid crystal display device according to claim 1,
wherein at least one of the end portions of the longitudinal-shaped portion is rounded.

15. The liquid crystal display device according to claim 1,
wherein the at least one high-speed display unit includes cross-shaped dark lines at a center of the four liquid crystal domains.
